(19) United States
(12) Patent Application Publication
(10) Pub. No.: US 2018/0136612 A1
(43) Pub. Date: May 17, 2018

(54) SOCIAL MEDIA BASED AUDIOVISUAL WORK CREATION AND SHARING PLATFORM AND METHOD

(71) Applicant: Inspr LLC, Boston, MA (US)

(72) Inventors: Daniel Zayets-Volshin, Boston, MA (US); Breno Felipe Rodrigues de Jesus, Belo Horizonte (BR)

(21) Appl. No.: 15/812,742

(22) Filed: Nov. 14, 2017

Related U.S. Application Data
(60) Provisional application No. 62/421,676, filed on Nov. 14, 2016.

(51) Int. Cl. G04G 13/02; H04N 21/854; G06Q 50/00; G06Q 30/06; G06Q 20/12; H04M 1/725; H04M 19/04

(52) U.S. Cl. CPC G04G 13/026; H04N 21/854; G06Q 50/01; H04M 19/041; G06Q 20/123; H04M 1/72583; H04M 1/72558; G06Q 30/0641

(57) ABSTRACT

Tools for the creation of audiovisual works that enable the creation of audiovisual works on mobile devices and the subsequent sharing of those works, as alarms, notifications and other forms of media, through social networks are herein provided and described.

### RELATED APPLICATIONS

This application claims the benefit of provisional patent application No. 62/421,676, filed Nov. 14, 2016. This application is herein incorporated by reference in its entirety for all purposes.

### FIELD

The invention relates to tools for the creation of audiovisual works, and more particularly, to systems and methods enabling the creation of audiovisual works on mobile devices and the subsequent sharing of those works through social networks.

### BACKGROUND

Alarm clocks, notifications and prompts have been a part of human lives dating back to at least the industrial revolution. Ever since strict timetables have been a necessity, so have devices that alert us to our schedules. With the advent of the smart device, a term which is herein used to refer to a mobile device, typically a phone, with significant computing ability, arguably today's most popular alarm clock and general notifier, alarms have evolved further into notifications, reminders, and other prompts that notify us of a huge multitude of scenarios, conditions, and, above all, times.

Although alarms, notifications, and other alerts have existed for quite some time, they have been primarily limited to sound. While some alarm apps and other devices display rudimentary flashes or other basic images, visuals are largely underutilized in the area of alerts.

Alarm clocks, by their very nature, also typically use the same sound every morning to wake up their users. While this can be useful to guarantee the user wakes, or that the alert is noticed, many times the user quickly grows tired of the sound, or begins to associate the sound with unpleasantness.

Furthermore, although alarm and notification choice has grown in recent years, the ability of an end-user to create an alarm or notification, or indeed other content, on a smart device without specialized knowledge has been missing.

Although there are some mobile audio workstations, such as Rebirth and Fruity Loops, these applications are based on a desktop model. As such, they effectively provide a replica of the desktop environment, which may be tailored for usability on mobile. Workflows and general usage, however, are typically identical to that of the desktop version. Although video effects filters are present in some applications, they are applied to the overall clip; no manufacturer has yet approached this set of audio and video effects and samples as performance tools within a uniquely mobile centered audio and video performance environment.

The ability of users to share alarms and notifications or transform the experience of being notified into a social one has similarly not been present in current state-of-the art devices. There are, for example, some applications exist that allow people to place a call that will wake or otherwise notify a third party. There are also applications that allow people to record short video loops with a single type of effect applied to those loops for sending to a third party. Applications that allow people to apply filters and effects to their photos are also available. There are no applications, however, that turn alarm clocks and notifications into a social network, specifically a social network centered around video alarms, where users are provided access to a large number of video, photo and other alarms and notifications that may be based on their interests, those of their friends, families, followers or simply those of people or groups that they find interesting.

What is needed, therefore, are techniques for providing a pleasant, long-term alarm and notification experience to end users that allows those users to create and share alarms and notifications that transforms the experience of being notified into a social one.

### SUMMARY

One objective of the present disclosure is to utilize the internet, variable visuals, sounds and the ever-growing market of social media to transform the experience of being awakened or otherwise notified at the appropriate time into a pleasant social experience by utilizing the full potential of today's smart devices.

Another objective of the present disclosure is to provide a social network that introduces the element of arcade performance to alarms and notifications. Embodiments can leverage smart devices into digital audio and video workstations that act as customizable multimedia performance environments with game-like functionality.

Embodiments of the present disclosure provide these missing features by offering a fully-fledged, mobile-centered performance environment that allows users to create a customized multimedia performance using a number of filters that may be applied to segments of clips or the entire clip, at the user's preference, enabling next generation performance artists to achieve recognition within a mobile platform by developing audio and video performance skills with their own customized and unique styles of visual filters, melodies, swing, patterns, choice of virtual studio technologies, automation and virtual studio technology effects, sound and visual triggered effects and morphed collections of audio and visual processed effects. Embodiments of the present disclosure are designed as an evolution from digital audio production into a full-fledged multimedia production and performance environment.

There are also a number of virtual studio technologies available in the various “app stores,” which are used to supply applications to smart devices, for purchase and for free download, but no current mobile application allows a dynamic social community to trade, bid, and exchange audio collections, video effects, virtual studio technology synthesizers and effects.

Embodiments of the present disclosure provide this missing social aspect, allowing a dynamic set of communities to be born around the platforms of the present disclosure through trading, bidding and searching for different rare and specialized signature audio elements and video effects, virtual studio technologies, drum machines, unique video filters and sound effects within a marketplace, further expanding the customization of the production environments to a very personalized mobile multimedia workstation.

Another feature unique to the embodiments of the present disclosure is the compression of elements in a feed or page based on the speed of the scroll, with the category highlighted above or over the scrollable content. This feature is referred to herein as “Smart Scroll” functionality.

Embodiments of the present invention provide the invention substantially as herein described.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram illustrating a splash screen, configured in accordance with one embodiment of the present disclosure;

FIG. 2 is a block diagram illustrating a home screen, configured in accordance with one embodiment of the present disclosure;

FIG. 3 is a block diagram illustrating a feed screen, configured in accordance with one embodiment of the present disclosure;

FIG. 4 is a block diagram illustrating a lower screen, configured in accordance with one embodiment of the present disclosure;

FIG. 5A is a block diagram illustrating a search field screen, configured in accordance with one embodiment of the present disclosure;

FIG. 5B is a block diagram illustrating a search field screen and showing a user fast-scroll section, configured in accordance with one embodiment of the present disclosure;

FIG. 6 is a block diagram illustrating an alarm index screen, configured in accordance with one embodiment of the present disclosure;

FIG. 7 is a block diagram illustrating a menu option that overrides the alarm settings set in the settings window, thereby allowing a user to get a specific type of alarm to be generated for the specified time, configured in accordance with one embodiment of the present disclosure;

FIG. 8 is a block diagram illustrating a record screen, configured in accordance with one embodiment of the present disclosure;

FIG. 9A is a block diagram illustrating one version of a trigger selection window, configured in accordance with one embodiment of the present disclosure;

FIG. 9B is a block diagram illustrating one version of a trigger selection window, configured in accordance with one embodiment of the present disclosure;

FIG. 10 is a block diagram illustrating one version of a trigger selection window comprising keyboard and record scratch modules, configured in accordance with one embodiment of the present disclosure;

FIG. 11 is a block diagram illustrating one version of a trigger selection window, comprising XY effects box and loop modules, configured in accordance with one embodiment of the present disclosure;

FIG. 12 is a block diagram illustrating one version of a trigger selection window, comprising knobs and buttons and user and 3^{rd} party developer audio and video effects and instruments modules, configured in accordance with one embodiment of the present disclosure;

FIG. 13 is a block diagram illustrating a multiplayer screen, configured in accordance with one embodiment of the present disclosure;

FIG. 14 is a block diagram illustrating a multiplayer screen with a scrollable profile view, configured in accordance with one embodiment of the present disclosure;

FIG. 15 is a block diagram illustrating an invite window, configured in accordance with one embodiment of the present disclosure;

FIG. 16 is a block diagram illustrating an edit screen, configured in accordance with one embodiment of the present disclosure;

FIG. 17 is a block diagram illustrating a publishing screen, configured in accordance with one embodiment of the present disclosure;

FIG. 18 is a block diagram illustrating a video playback screen, configured in accordance with one embodiment of the present disclosure;

FIG. 19 is a block diagram illustrating a feedback screen, configured in accordance with one embodiment of the present disclosure;

FIG. 20 is a block diagram illustrating a user profile screen, configured in accordance with one embodiment of the present disclosure;

FIG. 21 is a block diagram illustrating a public view screen, configured in accordance with one embodiment of the present disclosure;

FIG. 22 is a block diagram illustrating a settings screen, configured in accordance with one embodiment of the present disclosure;

FIG. 23 is a block diagram illustrating a marketplace screen, configured in accordance with one embodiment of the present disclosure;

FIG. 24A is a block diagram illustrating a bid screen, configured in accordance with one embodiment of the present disclosure;

FIG. 24B is a block diagram illustrating a buy screen, configured in accordance with one embodiment of the present disclosure;

FIG. 24C is a block diagram illustrating a trade screen, configured in accordance with one embodiment of the present disclosure;

FIG. 25 is a block diagram illustrating a feelings screen, configured in accordance with one embodiment of the present disclosure;

FIG. 26 is a block diagram illustrating a trigger selection screen, configured in accordance with one embodiment of the present disclosure;

FIG. 27 is a block diagram illustrating a new alarm screen, configured in accordance with one embodiment of the present disclosure;

FIG. 28 is a block diagram illustrating a comment screen, configured in accordance with one embodiment of the present disclosure;

FIG. 29 is a block diagram illustrating an invite screen, configured in accordance with one embodiment of the present disclosure;

FIG. 30 is a block diagram flowchart illustrating the interaction between record, edit and publish screens, configured in accordance with one embodiment of the present disclosure;

FIG. 31 is a block diagram flowchart illustrating the process by which a user can set up a profile and link that profile to other social media profiles and/or reset their password, configured in accordance with one embodiment of the present disclosure;

FIG. 32 is a block diagram flowchart illustrating the process by which a user can configure their profile, specifically how a user may configure a profile to be public or private, configured in accordance with one embodiment of the present disclosure;

FIG. 33 is a block diagram flowchart illustrating the process by which a user can browse their feed screen and browse individual objects in that feed, configured in accordance with one embodiment of the present disclosure; and

FIG. 34 is a block diagram flowchart illustrating the process by which a user can add and remove alarms, configured in accordance with one embodiment of the present disclosure.

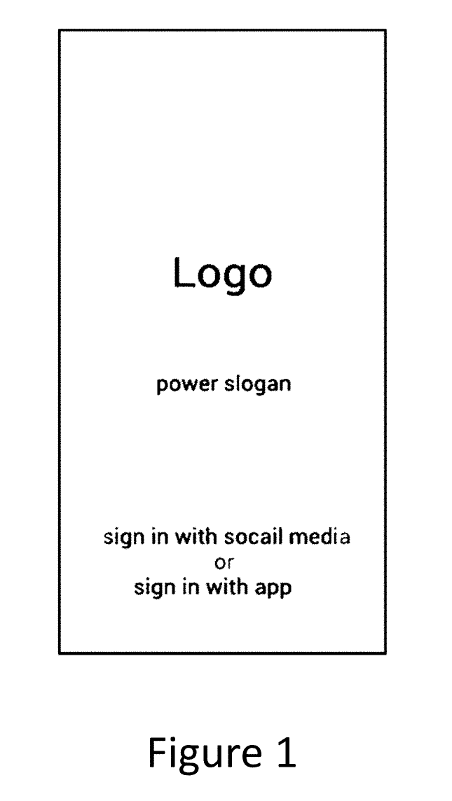

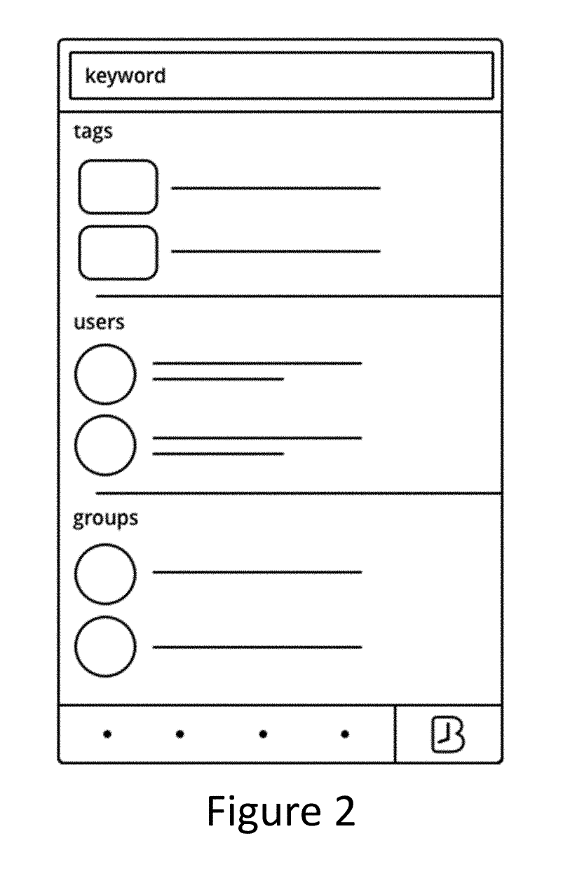

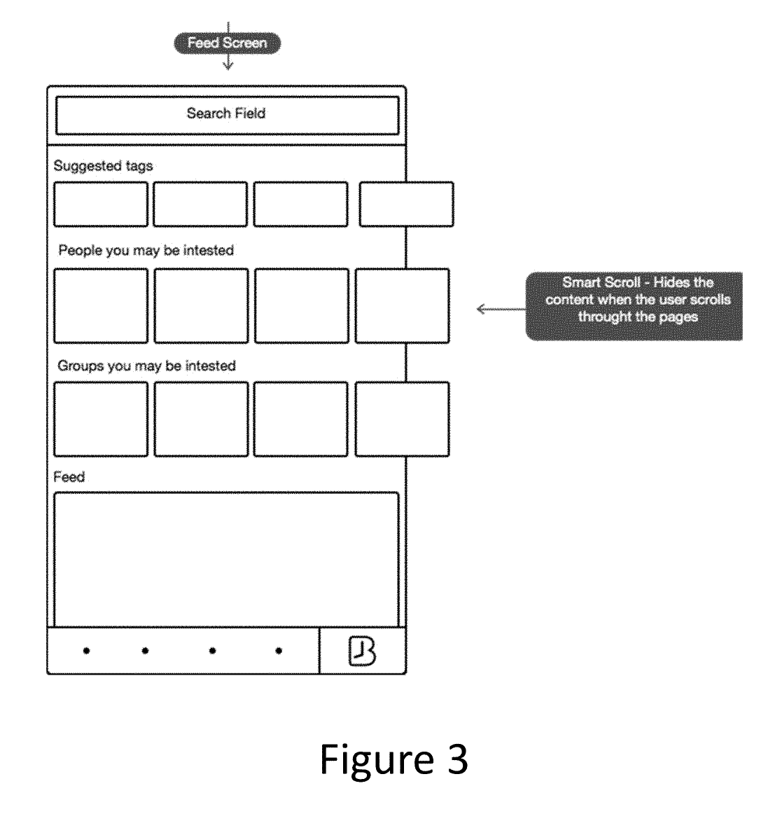

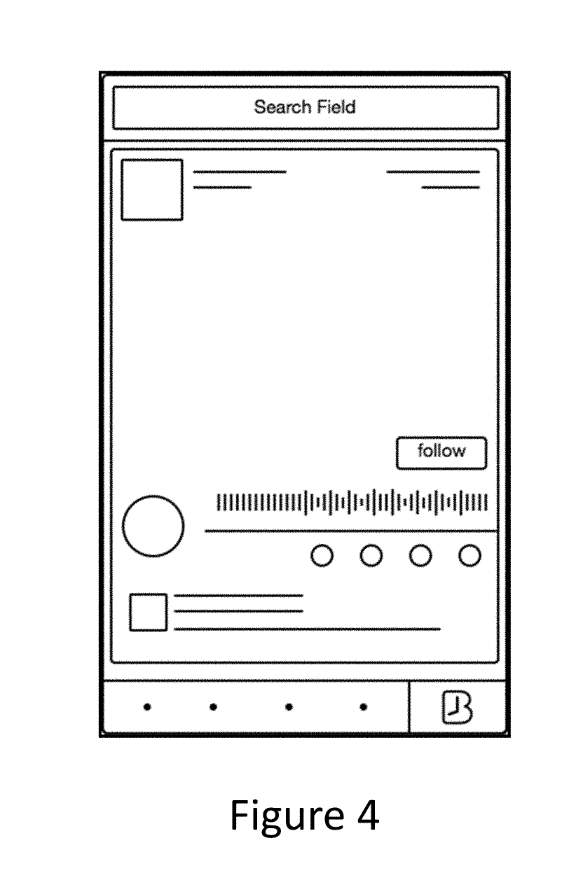

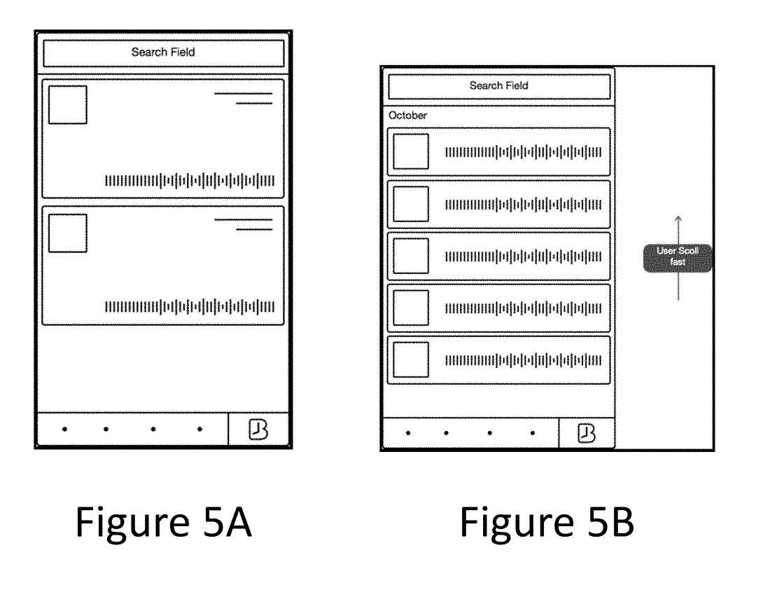

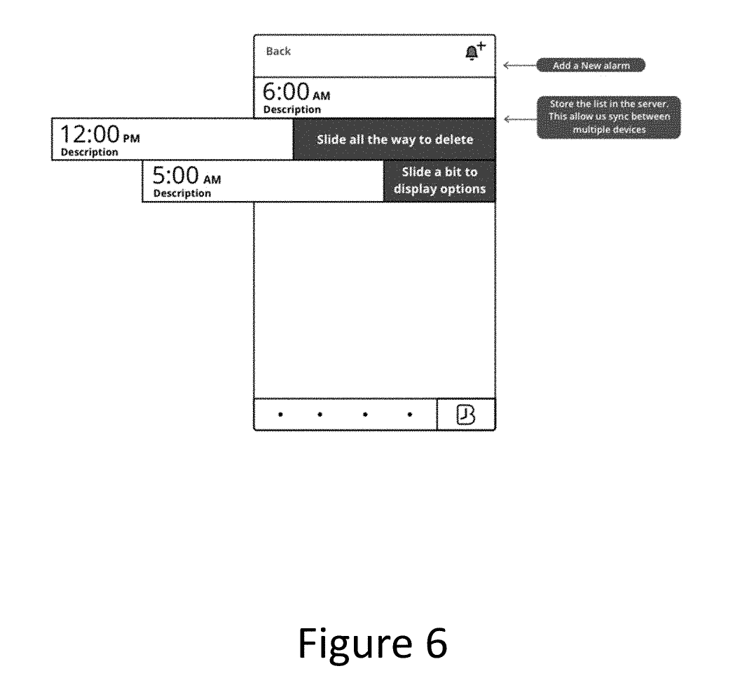

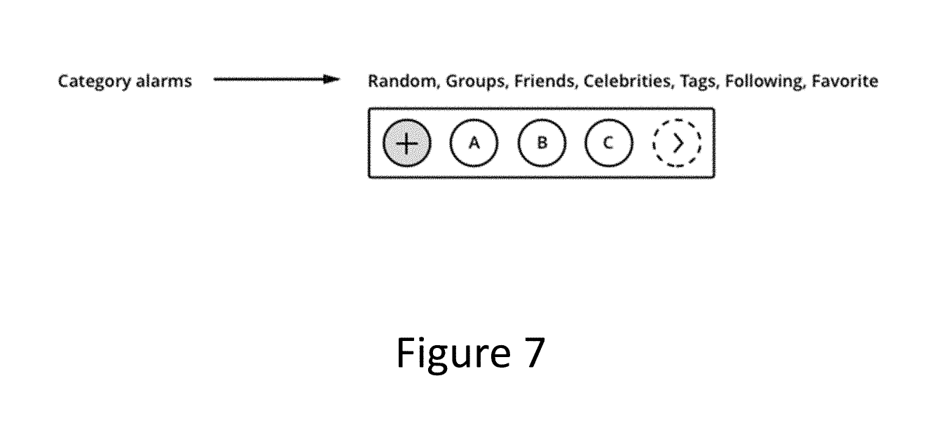

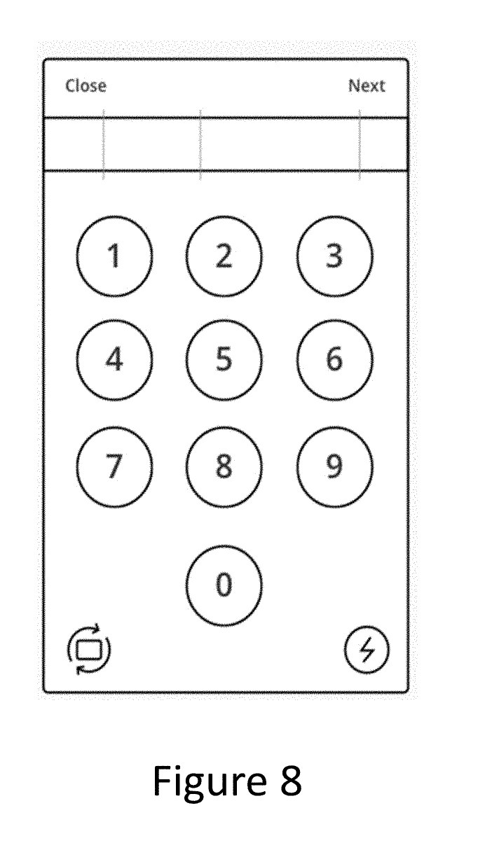

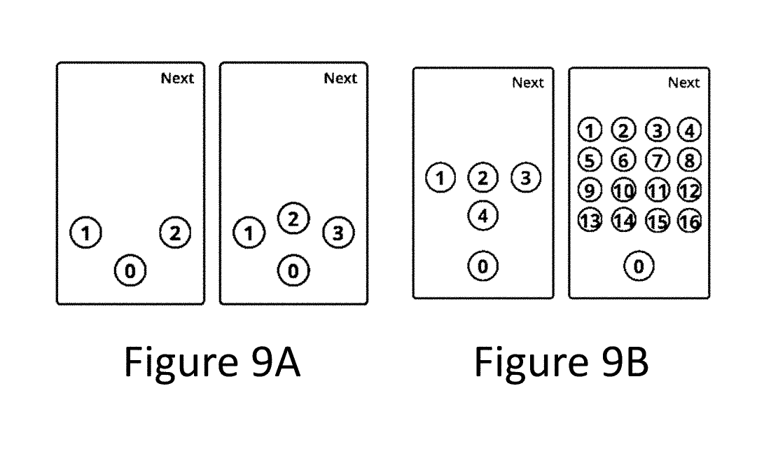

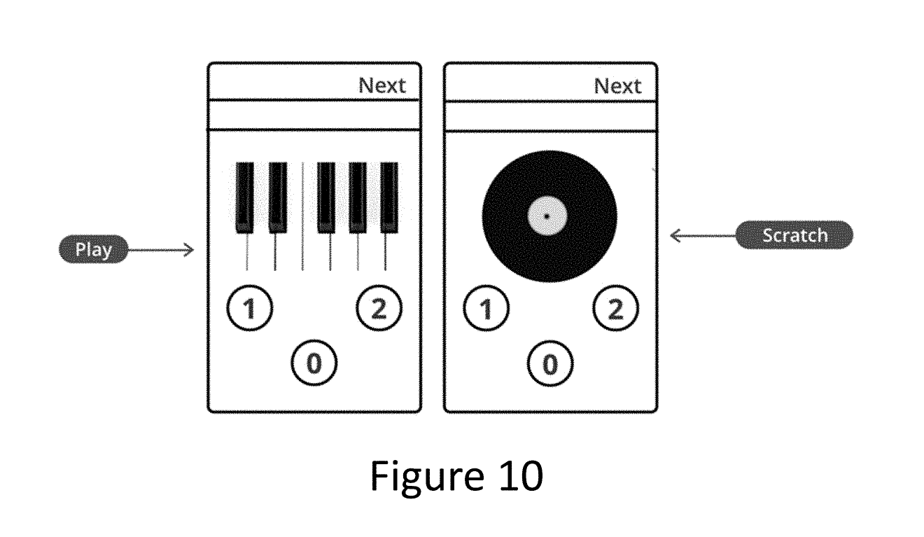

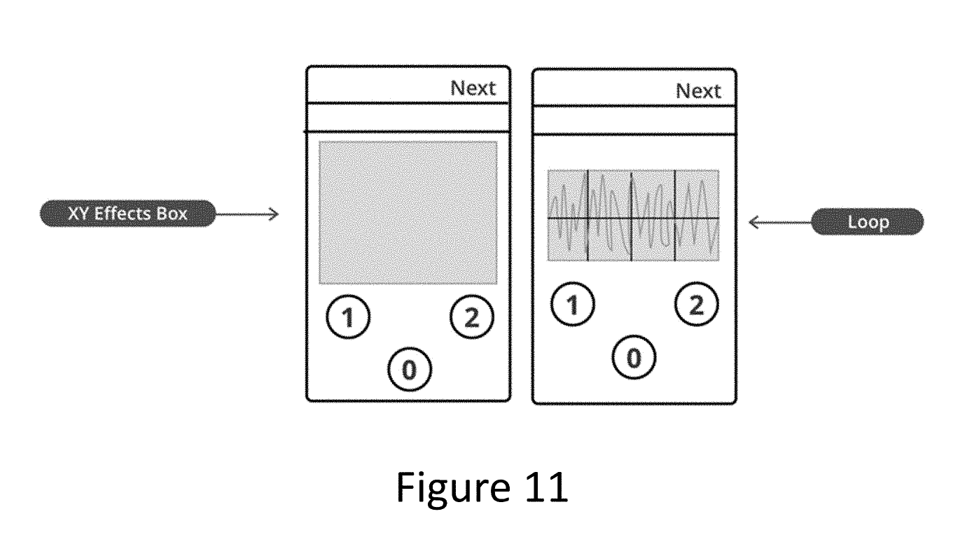

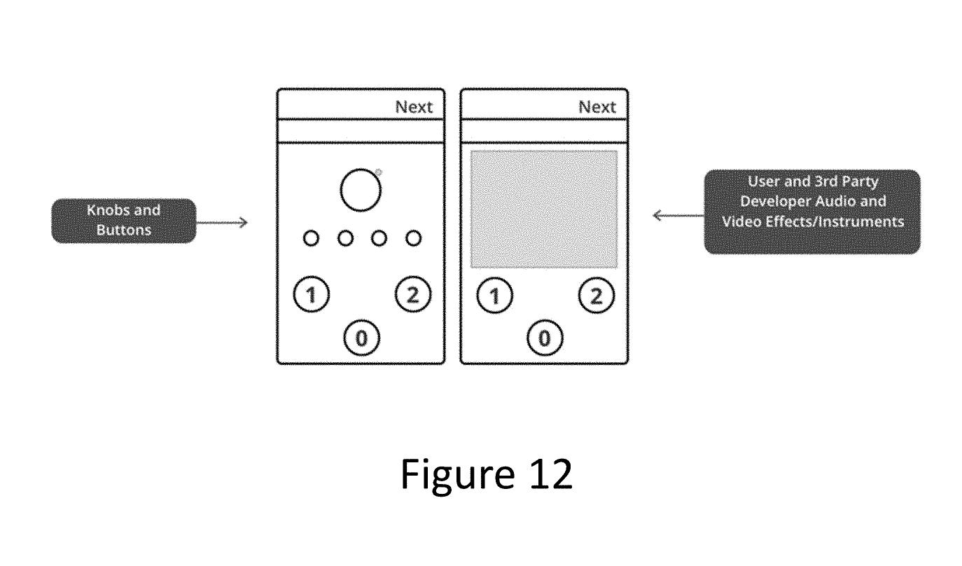

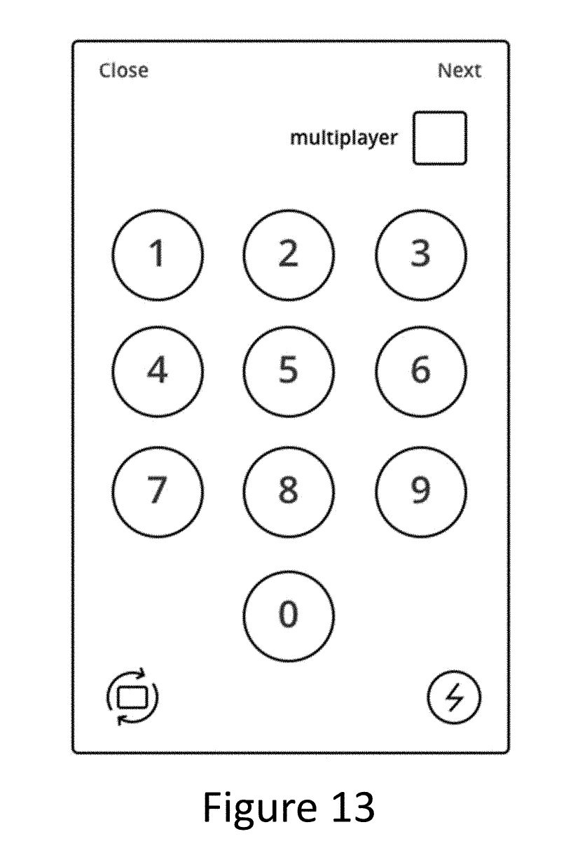

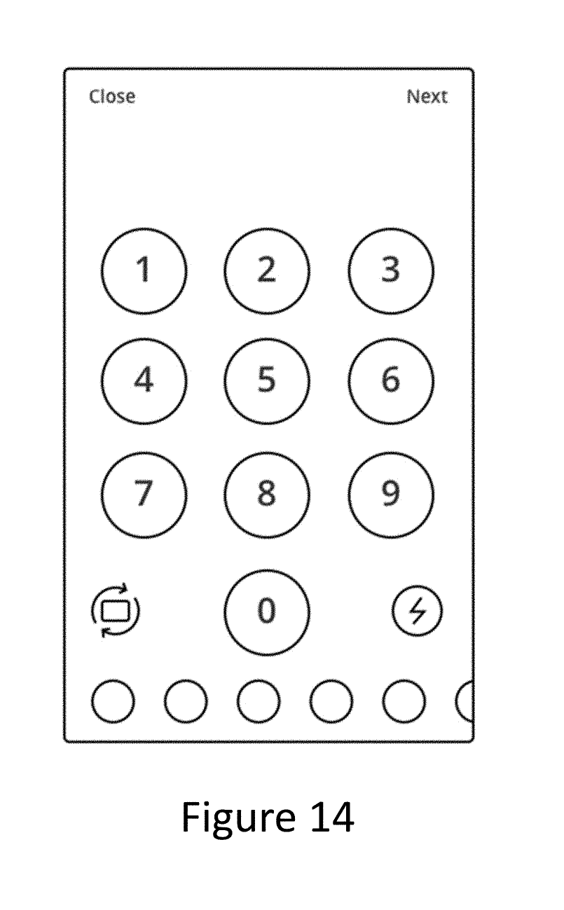

### DETAILED DESCRIPTION

Embodiments of the present disclosure provide a social media platform with variable alarm videos. Similar to other social media platforms, such as Twitter, embodiments comprise following a large variety of users, which, in embodiments, include celebrities, VIPs, friends and family. In addition to following individual entities, users in various embodiments can also specify their interests and hobbies, which can tap into a huge array of uploaded videos.

In embodiments, when a user signs up, they are asked to make a short video, and upload it to a social media service along with descriptive tags and indicators, such as #morningcomedian, #drillsergeant, #elvis, #stocknews, #fashion, and more. Once a user has completed this step, an algorithm may be used to align the available alarms to the user's interests. If the user chose not to record their video alarm, in embodiments, they can proceed to a different screen where they can search and follow people, groups, and topics, which may be organized by hashtags.

In other embodiments, after setting an alarm time, a user can expect a new random video to be generated for them from either a random pool of users or from those groups, users, and hashtags that they chose to follow. This may be configured to occur, in embodiments, every time an alarm is triggered to start. In some embodiments, users can continue to record and upload their own video alarms so that their followers have a new video to wake to every morning.

Embodiments of the present disclosure may also provide “trigger buttons” that are usable during video recording to trigger various pre-configured actions. In embodiments, these trigger buttons may be used to trigger basic video effects, sound effects, or musical samples. Additional abilities, as would be known to one of ordinary skill in the art, may be granted to these buttons, such as triggering virtual synthesizers and virtual studio technology effect units, thereby providing an arcade-like experience by allowing a user to play them during their recording process.

These buttons provide the basis for a massively customizable, tradable, and entertaining economy. In embodiments, thousands of new buttons may be offered to users. In embodiments, these buttons are opened up to 3rd party developers. Embodiments allow these new buttons to be purchased, traded and customized in a number of ways, thus making the experience of creating an alarm more like a game than simply recording a video. Unique buttons may also be offered during seasonal and special events, as part of promotional activities or as part of a rewards system built into embodiments of the platform.

Some buttons will naturally become rarer, as event and limited time buttons expire. This will allow these buttons to develop value, forming the basis for a trading system where users can offer, trade, and purchase buttons from other users, similar to how digital items are auctioned in online games like World of Warcraft and Counterstrike: Global Offensive. For example, embodiments allow a user who views a video with a desirable effect to seek out the button on the marketplace that would allow a user to apply that specific effect or combination of effects and acquire it from another user. If a user has no more interest in a certain button, he can place it on the marketplace for purchase.

Because of this implementation of customizable trigger buttons, embodiments of the platform will become something users will log into to have fun, not just share videos. These features provide the basis for embodiments to become a lasting phenomenon, as opposed to a fun, but fleeting, video alarm app.

Embodiments of the present disclosure also allow quantization of triggered elements (sounds samples, video and audio effects, visual filters as well virtual synthesizers (VST) and VST effect units). In this context, quantization is used to refer to the process of transforming performed musical notes, which may have some imprecision due to expressive performance, to an underlying musical representation that eliminates this imprecision. The process results in notes being set on beats and on exact fractions of beats In embodiments, quantization units may come in standard units such as to every 64th, 32nd, 16th, 8th, quarter, half and whole (full measure) as well as classic drum machine swing options of the classic Roland 808, 909, 707 AKAI MPC as well as some other new and innovative quantization models that are currently available in different digital audio workstations (DAWs) and drum machines. These can offer the user a way to create a highly structured, quantizable, and swing-like audio/video project in a mobile multimedia workstation environment, such as one would expect on desktop digital audio workstations such as Logic, Ableton, Cubase or Hardware Workstations like MPC. In this way, embodiments of the present disclosure offer users a way to have a high quality multimedia performance and AV editing environment that is designed from the ground up for mobile use.

Embodiments of the present disclosure may comprise various screens, such as: splash screens; registration screens; home screens; alarm index screens; record screens, which may have multiple trigger configuration, edit screens; publish screens; video playback screens; user profile screens; settings screens and marketplace screens.

Embodiments of the present disclosure may further comprise various windows, which should be understood to herein describe separate elements floating above a screen, such as: introduction windows; feelings windows; trigger selection windows; new alarm windows; comment windows; activity windows; and invite windows.

Various embodiments may utilize a window as a screen or a screen as a window, as would be known to one of ordinary skill in the art.

Embodiments of the present disclosure may further comprise persistent elements, which should be understood to herein describe identical elements present on multiple screens.

Still further embodiments may incorporate a search bar. Such a feature may be presented near the top of the screen in the form of a text box that displays a random message asking the user a question such as “How would you like to wake up tomorrow?” Tapping on this text box may launch the system keyboard and allow users to enter text. Users may search for videos by typing in a hashtag, category, or for other users. As text is typed in, categories such as groups, videos, and users may begin to appear below the text box. When tapped, each of these categories may expand and show a more detailed list. The user may select from this list by tapping on the desired category.

In embodiments, a user may conduct a search for specific users (@nic) tags (#morning comedian), use category names like “group:”, “celebrity:”, “channel:” or simply use keywords and key phrases in the search box which would display a combination of types of categories. This feature allows users to browse through their suggested tags, people the user may be interested in, groups the user may be interested in videos as well as channels and celebrities.

Beneath the search section embodiments may provide recommended tags, people and groups. These may be browsable by scrolling left to right by utilizing the aforementioned “smart scroll” feature, which compresses the scroll horizontally, making it smaller on higher speeds, thus allowing the user to scroll horizontally more quickly.

Other embodiments may incorporate a system notification bar. A standard iOS and Android system notification bar, including icons for time, Wi-Fi, Cellular Reception, other app notifications, and more may be included. They may be located at the top of the screen.

Still further embodiments may incorporate navigation tabs. Navigation tabs may be present at the bottom of the screen and marked by icons including HOME, COMPASS, PROFILE, BELL, and/or other icons. These tabs may take a user to different windows within the application.

Embodiments may include a number of screens. One screen may be a splash screen. The Splash Screen may be shown to first time users, and feature a logo. It may also feature the text “Wake up the Fun Way” below the logo, and the name of the application/service at the bottom of the screen. Scrolling to the right may bring the new user to a Registration Screen.

A registration screen in accordance with embodiments may comprise a logo, a button allowing for Facebook authentication, and a link to sign up with an email and password. In embodiments, the Registration Screen allows users to log in through Facebook, or other authentication services. This screen may also include an option to log in using an email and password. Once the user has registered, embodiments may include an introduction window.

Embodiments may also include a home screen. The home screen may be made accessible via a home icon tab at the bottom of the app.

Still even other embodiments may provide, in the center of the screen, a rectangular window that shows a thumbnail from the user's recorded video. Tapping on the play button, or anywhere inside the window, except on text or buttons, may be configured to open a video playback screen.

A user's profile name may be represented in the upper left quadrant of the application in the form of “@user”, with the user's profile picture shown to the left. Below the user's name may be a time specification which represents how long ago the user uploaded the video that is currently onscreen. Clicking on the user name or profile picture may take the user to a user profile screen.

Even further embodiments provide, in an upper right quadrant of the application, a counter that shows how many unique profiles have clicked the play button on a user's video. Tapping on this text may bring the user to a video playback screen.

Embodiments include a white play button in the center of the video window. This may be used to indicate that that a video is ready for playback.

Users viewing another person's video may be presented with a “follow” button in the lower right of the video window. When tapped, this button may change its text to “following.” Now, videos from the followed user will appear in the following user's Home Screen. Tapping the follow button again, may change the text back to “follow” and that creator's videos will no longer display in the Home Screen.

Embodiments may use vertical white lines positioned below a video to represent the audio levels of the video. Shorter lines may be used to show quieter sound and longer lines may be used to show louder sound. Clicking on this element may also begin video playback.

Embodiments may also include a feeling button, represented by two masks and a plus symbol, located in the lower left of the video window. When tapped once it places a heart icon, symbolizing that the user likes this video alarm. When tapped twice, it will open the Feelings Window, where a feeling can be selected. Now, instead of the two mask and plus symbol, the button will display the emotion that was selected in the Feelings Window.

Embodiments may also include, immediately below the video window, a description box for the video, written by the user. This includes hashtags that are selected by the user. Clicking on the description will open the system keyboard and allow users to write their own comment where they can share their opinion of the video and add hashtags. These hashtags are automatically synced with the video alongside the user selected hashtags.

Embodiments may utilize comments displayed below the description box, along with the name of the user that wrote the comment. Hashtags added by the commenting user are displayed in blue and function as a link to tag index of that hashtag.

In embodiments, clicking on a commenter's profile picture or name will bring users to the commenting user's profile screen, where they can view videos uploaded by that user.

At the bottom of the comment section there is a comment section which, when tapped, will expand and show additional recent comments, with an option to scroll down for earlier comments. In the settings the user would be able to customize how many comments, if any, should show up.

In embodiments, the “smart scroll” functionality that allows a vertical scroll compression through a number of different posts may be active on this screen, thereby compressing the elements in the vertical flow. A category or date can be automatically generated on top of this scroll triggering it only during the fast scrolling options. The traditional slow scroll may remain as-is without changing the size of the elements on this page.

Embodiments may include an alarms index screen, which may be configured to allow a user to add alarms. In embodiments, pushing a bell icon in an upper right corner of the application generates a popup window (a new alarm window). On this page, users can set and see the times that alarms were set to. They can mute or activate particular al arms.

In still other embodiments, it is possible to shift each alarm time to the right. Doing so may reveal a menu option that overrides the alarm settings set in the settings window, allowing a user to get a specific type of alarm to be generated for the specified time. If this option is not selected, then the type of alarm that will be loaded for the alarm time will be dictated by the settings set up in the settings window.

Even other embodiments may include record screens, where the user may record themselves using a phone's built-in camera and microphone.

Embodiments may feature a record button that allows the user to start recording with a tap, and pause recording with a second tap. This button may be located at the bottom of a screen (button 0). In embodiments, the button appears as a circle when inactive, and, when tapped, will show a white circle in the center to represent the symbol for recording. When tapped a second time to pause the recording, the white circle is changed to a pause symbol (two concentric vertical lines.)

Embodiments show the timeline for the video at the top of the screen and represented by a horizontal grey bar going across the screen. This bar may progressively change from grey to red when the user starts to record. Under the red bar, embodiments include concentric vertical white lines of differing length, representing sound levels at different parts of the video. As the user records, the bar may be configured to fill with red from left to right, representing the remaining time available (e.g. 30 seconds). The user may be allowed to flip the camera from the front to the back one by pressing the camera icon on this screen. The user may also be allowed to add a flashlight by activating it on this screen. Such a light may be triggered rhythmically, quantized or with patterns, thereby enhancing the creativity of the alarm recording process.

In embodiments, when a user pauses a video, they may be provided the option to start the recording again. These may be referred to as cuts and represented by vertical white lines across the timeline bar.

Users may also be provided the option to click on the timeline to travel back in the timeline and record over a recording they have already made. Holding down on the timeline, in embodiments, may be configured to allow the user to make more precise selections. Functionality for deleting sections may also be included.

In embodiments, once the time allotted is spent, a Proceed button may begin to pulse from off white to pure white.

In other embodiments, what is in the camera view may be displayed as the background of the window. Using the switch camera button may be used to swap which camera is currently recording. This button may be utilized during active recording.

Embodiments may also include trigger buttons above the record button. Users may be allowed to customize these buttons to instantly play a soundbite, sound effect, video effect, rhythmically applied video filter, animation effect, virtual synthesizer, or musical sample. This can include music samples created by the user or the multimedia instruments developed by authorized 3rd party developers. The user is able to quantize each trigger button as well. This allows the users to add a more professional and accurate touch to their multimedia recorded performance, since synchronization of elements via quantization models is vital in modern day music production and is a basis of modern music and video production as well as rhythm triggering instruments like drum machines and pad controllers. In embodiments, these buttons may be customized through the Trigger Selection Window, which may be configured to appear when an unutilized trigger button is pressed when not recording.

When a recording is active, trigger buttons 1-16 may be configured to trigger a selected effect. When an effect is selected, the trigger button may be configured to take on a visual representation of that effect, sound, filter, audio sample or video sample via an icon that may be displayed on it.

Two buttons may be present in embodiments, although more buttons may be added to allow for more complex and expressive multimedia performance processes.

In addition to buttons, embodiments of the application may feature an ability to add music keyboard, vinyl for scratching recording in real time, XY Pad for live effects processing and loop triggers that record and continuously trigger loop for the recorded video as well as other modules that can be featured instead of some of the trigger buttons. In embodiments, these modules would be acquired through the marketplace, just like trigger buttons, thereby allowing easy use of music and video alarm production with minimal input and minimal training while allowing users who are interested in more sophisticated processing to have that functionality with more sophisticated tools that they can acquire on the market place, as awards, though geo-location, as sponsorship or developed on their own through a 3rd party development kit and API, among other options.

Another feature present in various embodiments is the ability to record content with a friend or friends in a Multiplayer Mode, which may be referred to herein as a duetto (for 2 people), trio (for 3 people), quartet (for 4), quintet (for 5), chamber (for 6-15), and orchestra (16+ people). When the Record screen loads there may be an option in the header to display a multiplayer mode.

Embodiments may also include, in the footer of the screen a scroll with profiles of friends scrollable to the left where a friend or multiple friends can be selected. Selecting a friend or multiple friends would allow a user 1 to send the invite to a friend or multiple friends (user 2 or more) via an invite window that will show up on the screen of the friend(s). By agreeing, both players would be able to perform and record a Duetto/Trio/Quartet etc. and then edit the video and audio in an edit screen.

The edit screen of various embodiments may include a next button in the upper right corner. Pressing a publish button may take the user to the edit screen. In this window, a user is able to edit and process the recording with functionality effects that are hidden behind each track. By swiping right and left the editing and post production/sound/video effects will reveal that are hidden. Once the effect is selected it's controls or zoom may be showcased in the lower section of the application window, where embodiments may include a large knob with another dot controller, which may be similar to the trigger selection window with smaller knobs/buttons, for example, controllers of the compressor such as attack, decay, sustain, release as well as a selection of different modes of compressor such as digital, tubes, optical and distortion.

A back button may also be present, in embodiments, at the upper left. Pressing this would return the user to the screen they were viewing before going to the record screen.

Once edited, a user would be able to access a publish screen, in some embodiments via the next button.

The Publish Screen of embodiments is where the user can name the video they have just recorded, as well as tag it with categories, add descriptive hashtags, and a description, if they choose. Once they finalize the additional information, the video may be sent to a server, and then distributed to everyone with associated tags or hashtags specified in their User Profile Screen. Other users that have followed the uploading may also receive a notification that a new video has arrived.

Various embodiments may also include a ranking system, allowing content to either rise up in a listing or descend in a listing. What determines this are the “feelings” assigned to it in a feelings window.

A user may also be allowed to tag friends that are using the application or those in other social networks. In order to target a user outside of the social network the user is required in embodiments to integrate the application with the social network that they want to use, such as Facebook, Twitter and YouTube.

In embodiments, a user may also have favorite people to tag in the profile tagging section of the window and pressing the arrow button may be configured to reveal other favorites that can be dragged to top favorites. Pressing a + button may allow a user to locate a new user that is not in their favorites.

Sharing options may allow users to share an alarm via popular social networks. Such an option may take the form of a switch that, when active, will automatically post the alarm to their social network of choice once they click the publish button. When the social option is not enabled the publish button will only release the alarm to a network associated with the application.

Embodiments also allow users to send specific alarms to specific users and/or custom groups of users, which may be manually or automatically generated. Such functionality opens up these embodiments' ability to be used for specific video reminders/notifications for individuals or groups. For example, a daughter might send her father a video reminder in a specific time to pick her up from a sporting event. Alternatively, a project manager might create a group comprised of members of his team and send the entire team a video notification/reminder on a specified date and/or time about a particular project milestone.

In embodiments, this feature integrates with other calendars, such as Google and iCloud calendars or calendars from project management systems. Some embodiments further provide the ability to locate a particular event or events in a calendar and synchronize those events to the application of the present disclosure, thereby allowing notifications about the events in advance or right on the event's designated date and time as well as to push that event or pre-event notification to a friend inside the social network of the application of the present disclosure. Embodiments may also allow such notifications to be pushed outside of the network.

In embodiments, by default, a user 1 receiving a notification from a user 2 for a reminder would initially be asked whether to use add a notification from that user 2 to their alarms index screen but the user 1 would be able to also add the user 2 to the trusted list of users (the same can be applied for the groups) therefore allowing a user 2 automatically add notifications to the user 1's alarm index without asking for a permission within the app or without the push notification. For example, this feature can be effectively used by family members to leave a short video messages for a specific member of the family as well as an entire family instead of calling each individual member of family with a specific video reminder/notification.

In embodiments, this feature can also be used with a Geo Location or age location pushed to users of specific age or specific location. Such added functionality effectively allows the platform to act as an event announcement system, in addition to its other functionality, as described herein.

As a practical example of the utility of such functionality, a celebrity may use this function to announce to all of their fans who are in a specific group an upcoming show in their city or area. This would allow all “followers” to get a specific alarm added to their alarms index specific to the celebrity's visit to their city.

Such functionality may additionally be used to provide monetizing opportunities. For example, an API could be used to synchronize such events with other apps that might deal with events or tickets, and, in the process, charge an additional sum to any orders made through that provided link that could be transferred back to the referring app.

In further embodiments, social media videos and content could be incorporated into the application of the present disclosure. In other embodiments, this functionality may be two-directional, with the application of the present disclosure able to upload content, including audio and videos to social media.

Additional features that may also be a part of the publish window are the age and content marketing of the alarm. The purpose of these settings is to warn the viewer of inappropriate content. These settings may be brought up during the initial registration process, and may include categorizations such as rated R content for violence or Adult content as MA. The user may be required to mark their age.

A user may also be allowed to tag a video alarm with its duration so that a user can mark the alarm to become inactive with specifications like “1 Hour only”, “Today Only”, “This Week only”, “This Month Only” or “This Year Only.” Such a setting may be determined by the uploader of the video. Such functionality would allow users who record those video alarms to use the app for news distribution objectives, or any other time sensitive objectives. Ex: A news channel releasing the news relevant just for this hour and not relevant for the next one (such as stock updates) or artists doing their alarms with info at the end on their tour dates this month

A back button may also be present at the upper left corner of various screens. Pressing this will return the user to the screen they were viewing previously.

When video playback begins, a new screen may be configured to appear so that the video can play in the ratio that the video was recorded in, and video may begin playing in this new screen. The user name, profile picture, and upload time is present in the upper left of the screen. A follow button may also be present in the video playback screen in a lower right corner. A “today only” designation may also be provided, in some cases in the upper right of the video playback screen, and be used to represent that the video will only be available for one day. There may also be an x symbol inside a circle in the center bottom of the video playback screen. When tapped, playback may be configured to stop, the video playback screen closes and the user is returned to the previous screen or exits application entirely.

If the user has received an alarm during their set alarm time, the next alarm may be configured to start playing after the first video is completed, until the user turns the alarm system off by pressing the exit/close button. The functionality of how many alarms would play one after another may be managed in the Settings Screen, where such multi alarm playback features could be disabled altogether. In embodiments, if the user wants to go back to the previous alarm or go to next alarm, all they would do is swipe the screen left or right and the application will load and start playing either the previous video alarm or play the next one.

In embodiments, if the user touches the screen while the video is playing, the video will stop, if the user touches the screen again the video will start to play again.

In other embodiments, if the user double taps anywhere on the screen, the video alarm will restart from the beginning

In still further embodiments, if the user tabs on the mask, a positive review will be left and if the user double taps on the mask section a window of feelings will open up.

Embodiments may further comprise a user profile screen, where user information may be presented. This screen may be divided into a top account part and a section that consists of tabs and scrolls through video alarms.

According to certain embodiments, in a top part of this screen, which may be referred to as a personal view of the user profile screen, the user is able to change their profile picture, update the slogan, view people who follow them, who they follow, friends, groups, tags, celebrities and channels that they are part of. They also have access, in embodiments, to their statistics and settings windows. Two features of this screen, present in various embodiments, are a miniature growth or drop chart of new user acquisition positioned right next to the Following tab for a quick reference. Timeframe duration (day, week, month, year, all) may be determined in the settings window.

Beneath profile info on the personal view of embodiments, may feature a number of tabs, which may be referred to as a mid-section. Some of them will outline the user activity, others will outline different categories and other menu options for items that are user specific that need sorting via the scroll.

An activity tab may be used in embodiments to show a title at the top of the screen with the text “Activity.” Under the text is the window itself. At the top of the window, a phrase showing the number of new activities can be shown in the form of “You have x new notifications,” where “x” stands for the number of new notifications present and unchecked.

This window may also include a lower section. Beneath each of these tabs the page will unfold into a continuous scrolling section such as user activity or specific content scrolls such as user recorded content, and content that was favorited by the user.

The activity tab may be used, in embodiments, to list all of the interaction the user has had with other users. When other users interact with the main user's videos, a new notification may be generated and shown in the activity tab. In the activity feed a new interaction is noted with the user that made the interaction, and what they did. For example, if a first user marks a video of a second user with a “happy” feeling in the feelings window, this will be displayed in the second user's list, along with the first user's profile picture, a thumbnail of the video, and an icon showing which feeling was selected. And if the second user has posted content or watched someone else's content such notification will also be displayed in this Activity tab.

Content that may be featured in this section allows a user to access all of the content that was marked by the user at some point during their use of the application.

On the lower section of the screen, the user may also be able to select their favorite alarm(s) by pressing and holding an icon. The favorite alarm(s) can later be set in an alarm index screen as the alarm that user would receive if the user does not want to wake up to random content.

The lower section may be configured to open up other scrolls, such as a scroll of profiles of the followers, following, friends, groups, celebrities, tags and channels that the user is involved in.

The application may also feature a public view window having a top section intended to showcase basic information about the user such as the profile photo, power slogan, people the user is following, followers, groups, friends, celebrities and channels a user is a part of. The top screen may also feature a back button, to come back to the screen or window from which the profile screen was initially accessed.

The public view window may also feature a lower view section. Beneath the top user information a user recorded content feed may be featured. This lower section can also open up other scrolls such as a scroll of profiles of the followers, people following, friends, celebrities, tags and channels and groups that the user is involved in

Embodiments may also include a smart scroll, as is discussed in more detail below. As content is scrolled, it may be compressed to smaller elements according to the speed with which the user scrolls through the section, thus allowing the user to cover a much larger amount of content than a traditional scroll would, while displaying particular indicators on top of the scrollable sections to help user navigate through the scroll.

The User Profile, in embodiments, may also be configured to compress as well, becoming narrower with lesser information at the header of the page when the page is scrolled down.

An editing button may be used, in embodiments, to switch its position as the following, followers and friends buttons are scrolled to reveal more buttons like tags, celebrities, groups and channels

In embodiments, any content snippet that is short clicked on in the user profile screen will open up a video playback screen.

In other embodiments, any profile that is clicked on in the user profile screen will open up, allowing that other users full version of the user profile screen.

In still other embodiments, any group snippet that is clicked on in the user profile screen will open up a full version of the group that may feature snippets of different user profile screens or different video playback screens. Any channel snippet that is clicked on in the user profile screen may be then configured to open up a full version of the channel that can either feature snippets of different user profile screens or different video playback screens.

In still even further embodiments, any tag snippet that is clicked on in the user profile screen will open up a full version of the tag will feature different video playback screens.

Embodiments may also include a settings screen. The settings screen may feature various categories of settings, including: content from, which allows a user to set up exactly what type of alarms the user wants to receive every single time. Embodiments utilize an algorithm to mix the selection up.

Settings may also include preferences, which would allow the user to keep the phone on vibrate, with wearable as the disturber and only use the visual component of the application. It may also be configured to provide an ability to have a fall back alarm in case of no internet connection, have alarms rotate one after another, switch between military and AM/PM time, display favorited content, remove trigger buttons, select the timeframe of the “people following button” chart and lastly select a number of posts displayed at a video feed.

Settings may also include notification settings, which may allow a user to get notifications on their device from groups, people and tags selected.

Embodiments may also social network settings to be changed. This feature would allow users to connect the application to popular social networks, allowing the user to effortlessly share content on other social networks and tag friends on those other social networks as well

Settings may finally include coupon codes. Coupon codes may be configured to allow users to open up “Magic” functionality of the system in particular connected to trigger buttons, samples, audio/visual live and post production effects, as well as VSTs, VST effects, Keyboard, Scratch, XY Pad and Arpeggiator, Loop Players, Step Sequencer Modules, Quantization and Swing Models for triggers, recording time extensions, personalized sample upload, life extension for certain triggers as well as Sponsor or promotional functionality for the record screen, editing screen as well as marketplace screen, Home screen, Playback and User Profile Screen, points modification and other user beneficial engagements. The Coupon Code may be used to create a powerful environment to modify and personalize the application in a number of different ways specific for each individual user.

Embodiments may also include a marketplace screen or screens. This set of screens may be configured to allow a community to purchase, bid and exchange a number of features of the app. It may target the trigger buttons, effects, modules and quantization modes in the record screen but also for the effects, filters and saturation models for the edit screen. The set of screens may comprise out of the selector screen to choose the type feature: Performance Effect, Filter, Sample, Video Effect, Keyboard Module, Post production Effects, etc.

A marketplace channel may be provided in embodiments, allowing users to buy, sell, bid or trade to something else with the presentation of collections or individual buttons upon selection and actual collections, buttons, features and modules available beneath either in a scroll, pagination or further categorization as well as include individual screens to perform a particular action, such as buy, sell, bid or trade.

The design of the marketplace screens may be altered, as would be apparent to one of ordinary skill in the art, as the interface would become more sophisticated accommodating more features but the functionality of it should remain consistent. An objective of this interface is to create an active community who is involved in customization their multimedia performance set ups from the standpoint of audio and visual performance elements as well as post production mixing and editing process.

In embodiments, users may be allowed to buy, earn, trade, geo locate and “get infected” with those features and buttons, modules and modes. A user's participation with the application's features, such as recording of multiple videos or generating a lot of likes, social sharing and internal sharing and commenting, spending a lot of time on the app or contributing to the indexation of the alarms would allow users to get features that they could trade or sell on the marketplace.

Even though the marketplace is intended to deal mostly with record screen and edit screen, it could also be used for other features and/or to enhance the overall look and feel of the app as well as adding some interesting features and functionality to be bought, traded and sold and affect other screens and windows.

The marketplace, in embodiments, may also be configured to allow a user to sell merchandise, such as t-shirts, cups, hats, jackets, hoodies as well as midi and Bluetooth controllers to control the application physically with them, thus further personalizing each multimedia performance and editing setup.

The application may feature a number of windows, such as an introduction window.

Introduction windows, in embodiments, provide a way for the user to learn about the app before using it. Scrolling to the right may allow users to learn about the app. Scrollable screens that detail the operations of the application may be made available.

Slides may comprise:
1: “Choose the categories of your preference” will be shown in text. An image of hashtags floating will be shown.
2: “Set your alarm” will be shown in text. An image of a ticking clock will be shown.
3: “When it's time to wake up, [Application Name] will generate an alarm for you” will be shown in text. A video of the person in the video player will be shown.
4: “The more you use the app, the more your alarms will be customized to your taste!” will be shown in text. A picture of a funnel with “more generic” at the top, “less generic” in the middle, “specific” near the bottom, and “You” at the bottom will be shown.
5: “Take it to next level—RECORD your [Application Name] Alarms today and become a morning celebrity. START NOW” will be shown in text. The “START NOW” functions as a link, which when tapped scrolls down to the final screen, where users can register.

The slides serve at least two purposes, to provide a basic description of how the app works and to allow the user to register and log in to the application and, in embodiments, affiliated social network.

Another window present in various embodiments is the feelings window. This window may comprise a plurality, such as 9, of circular buttons. These buttons may be configured to show visual representation of emotions that users can select to share their feelings about the video. When tapped, a button is highlighted. If another button is tapped, the previous button loses its highlight and the new button is highlighted. Embodiments may also include an “x” inside a circle in the center bottom of the feelings window that allows the user to return to the previous screen.

Feelings may also double as a content filter, with videos that get too many negative reactions descending down the list of their selected category(s).

Still further embodiments include a trigger selection window featuring selectable buttons that appear above the recording window. These buttons may be made accessible by tapping on the triggers button present on the recording window. Each of the selectable buttons may be configured to show a visual representation of the audio, video, audio effect, or video effect (VST) that is assigned to that button. These buttons may be preassigned or customizable. In embodiments, users can upload samples and 3rd party developers may release instruments sample collections for this window.

The button currently being interacted may be configured to display a small dot next to it—this is the controller that will allow to control the quantization, swing and other effect placement percussion. In embodiments, the dot controller may be configured to allow controlling the density of the effect and other elements specific to the triggered element. Once the trigger is selected in the trigger selection window and the window is closed, the user is ready for the recording process. In embodiments, clicking anywhere outside of these buttons will bring the user back to the recording window. Clicking on one of these buttons will instantly assign that effect to the trigger button, and the user will be returned to the recording window.

Still even other embodiments feature a new alarm window. This window may be configured to appear when the bell icon on the alarms screen is pressed, or when the user taps a certain alarm on the alarms index screen. A time for the alarm will be displayed, as well as two sliders below the time. Below that, a window where users can name their alarms using the system keyboard may be presented, which will appear when the window is tapped. Below this is a button that allows users to save the alarm. Below the save button, is an x in a circle that functions as a cancel button for users to return to the Alarms Index Screen.

This window may also features two sliders in the form of concentric vertical lines. The top slider for hours, and the bottom slider for minutes. Both 12 hour and 24 hour clocks are available, and can be changed in the settings window. When using 12 hour, the slider will simply switch to p.m. on the right half, while the left half is for a.m. times, and the time above the sliders will reflect this with an “a.m.” or “p.m.” next to the time. The 24 hour slider will simply go between 0 and 23. The minutes slider remains the same for both styles and goes between 0 and 59.

The new alarm window, in embodiments, may appear as a raised window above the alarms index screen.

Still even additional embodiments feature a comment window. This window may be configured to open when the user selects the comment button on the feed screen or video playback screen. The overall view of the comment window may be substantially similar to the publish screen and allow a user to write text and tag the message with the appropriate hashtags either within the message or after the message Just like in the publish screen, the commenting user, in embodiments, may also be allowed to share the alarm within their feed of another social network.

Even addition embodiments feature a content feed window.

The content index windows, in embodiments, may list an index of content, which may include video alarms, cards. It may also include a number of categories such as other user content, content that a user applied a feeling to in the past, content of friends, content in a specific group, content from celebrities, content in a specific tag category, content of specific news channels, celebrities, people following, followers friends and other.

The index of content, in embodiments, may be listed in a scroll format that can end being an endless scroll. In embodiments, scrolling content is ordered from most recent at the top to the older ones in the bottom.

The aforementioned “smart scroll” technology may be used here, in embodiments. As the user scrolls faster through the feed, the header section gets smaller, the size of content cards decreases, allowing to package more cards closer together and in a narrower space and allowing to scroll through a larger amount of cards. As the scroll continues, dates of the content are displayed over the scroll to provide a reference points in time. As the scrolling slows down the content on the screen at that time go back to the regular web site.

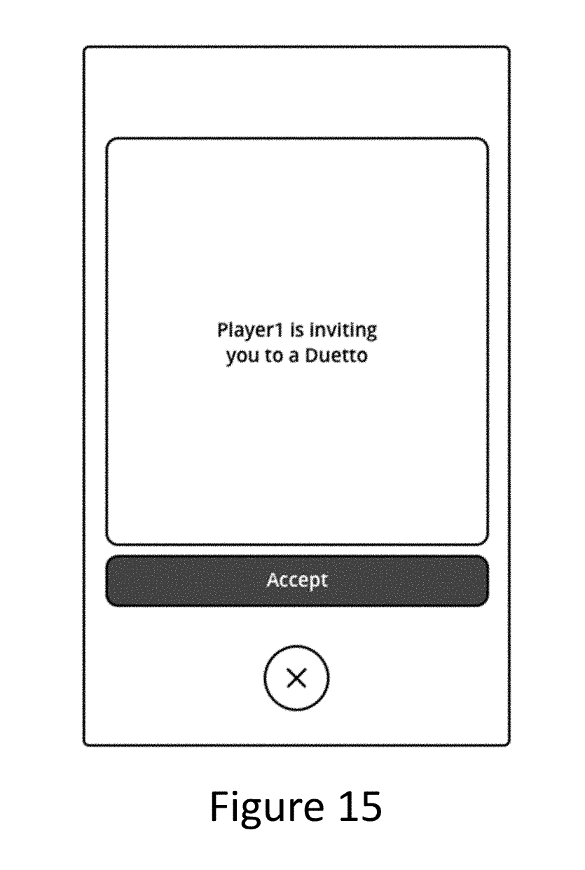

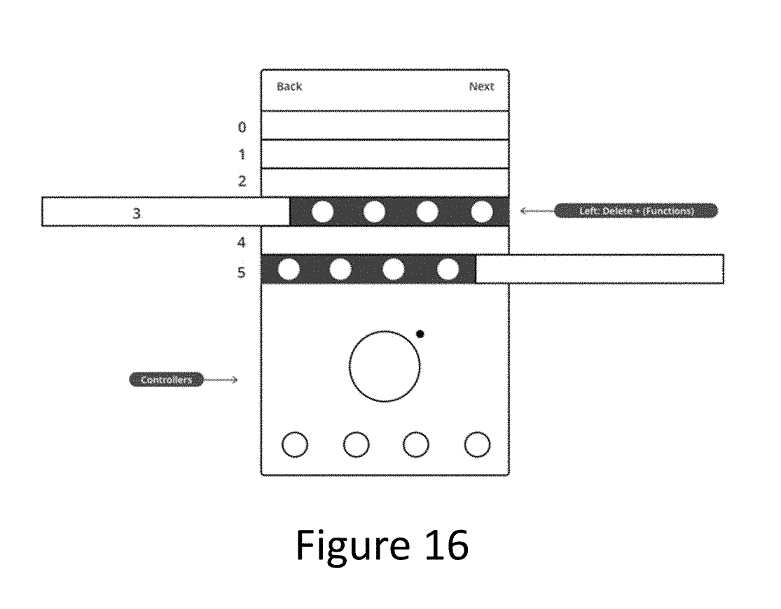

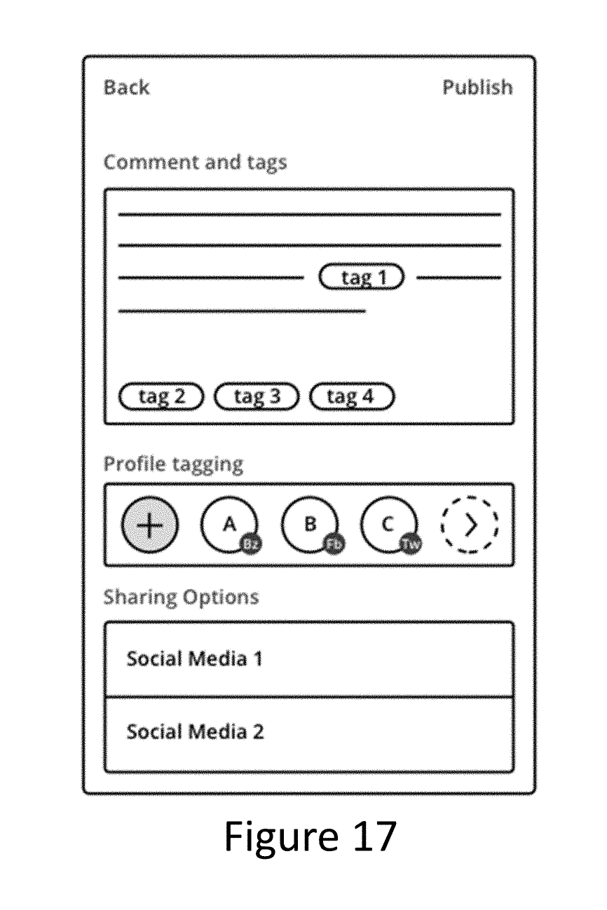

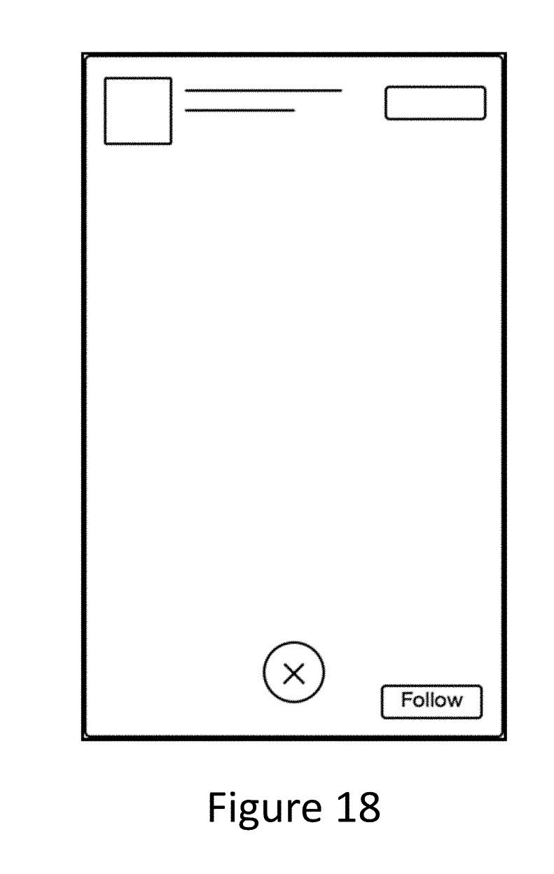

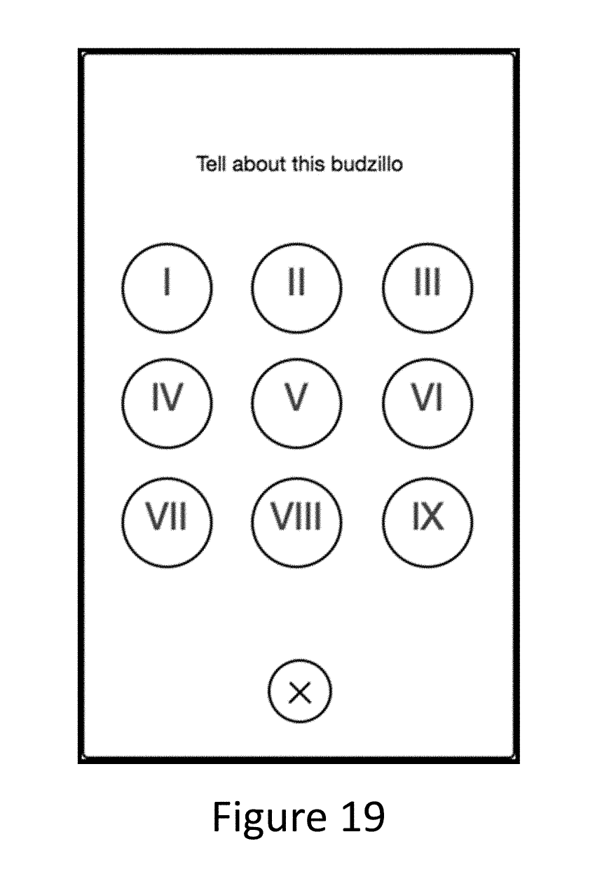

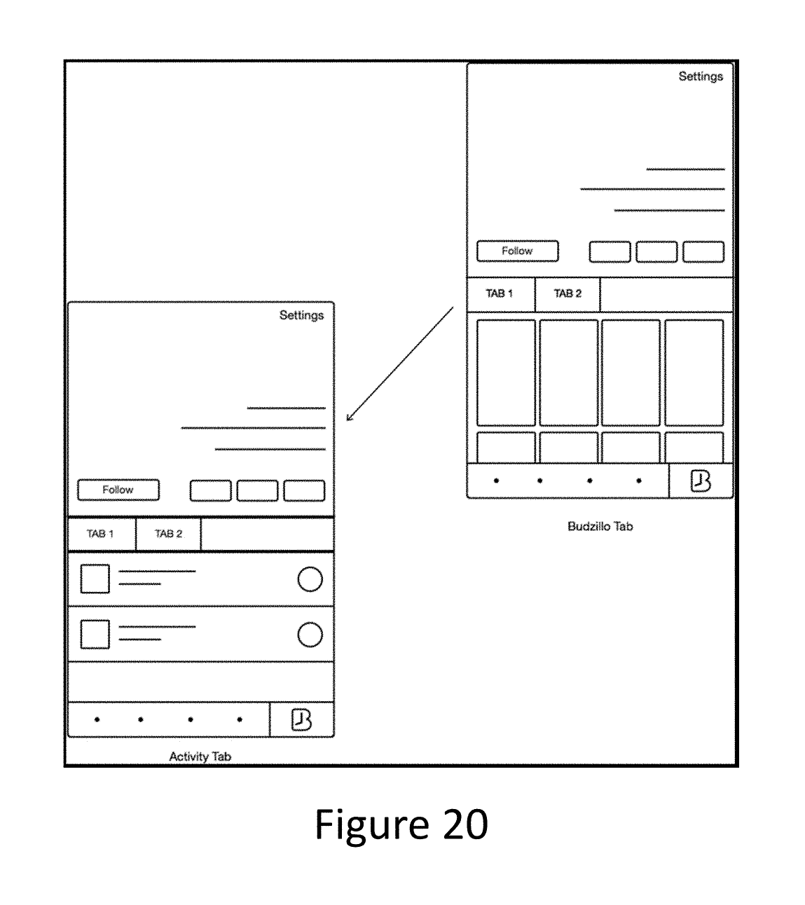

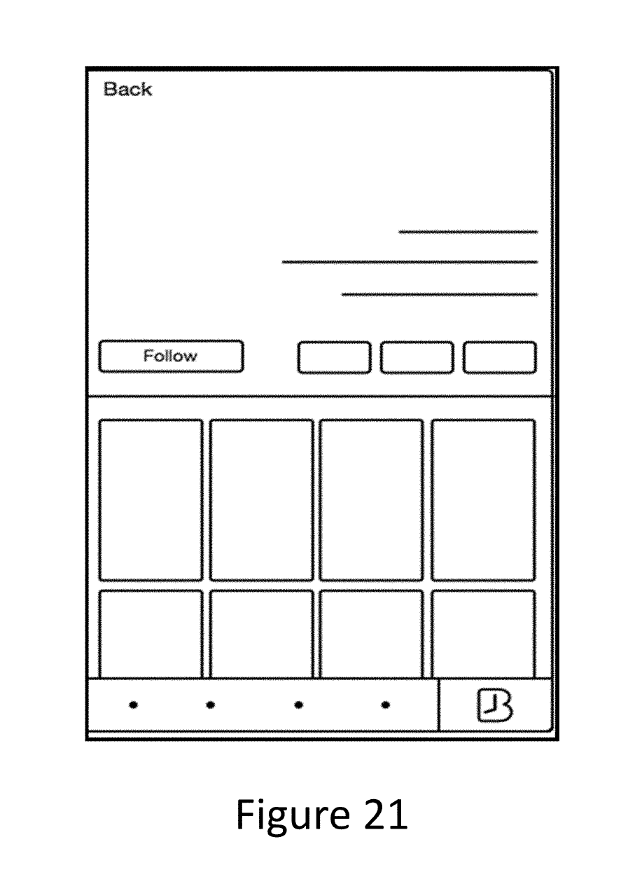

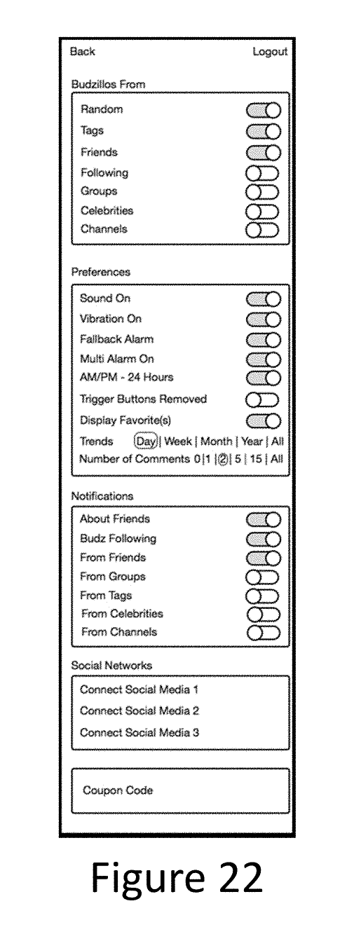

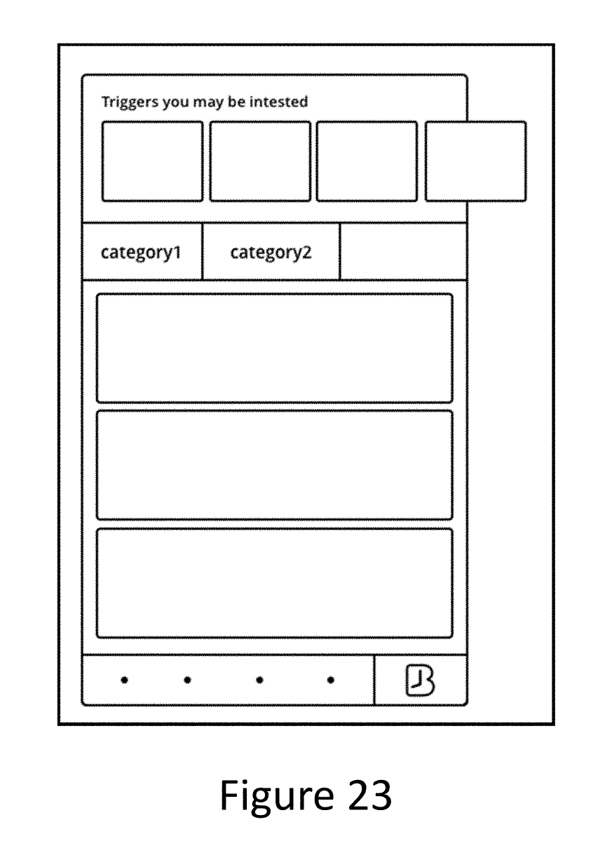

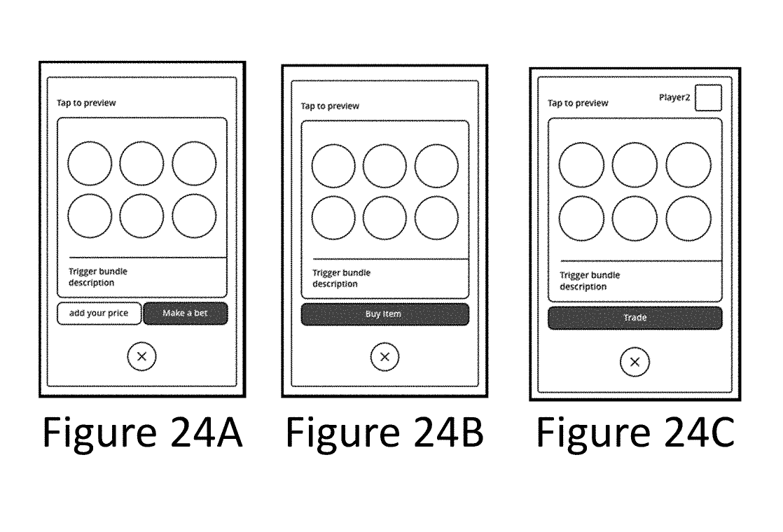

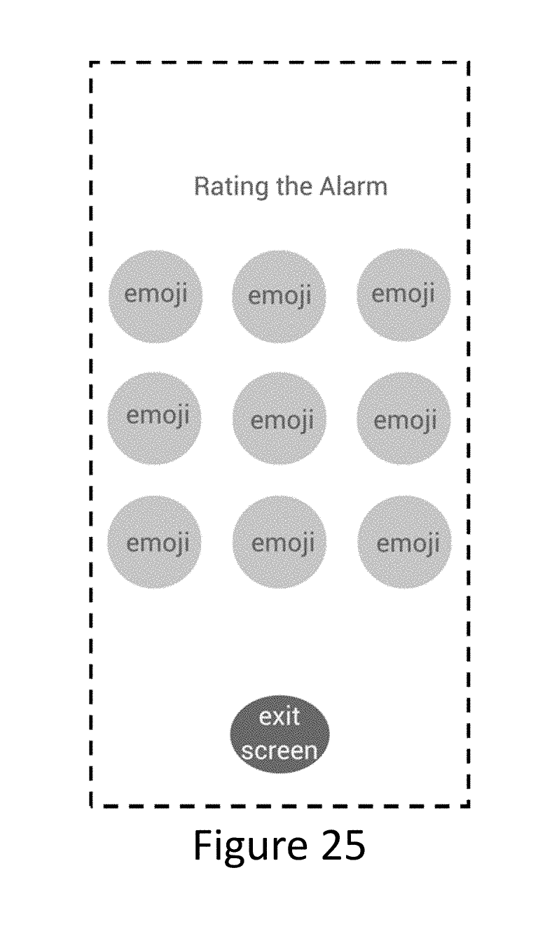

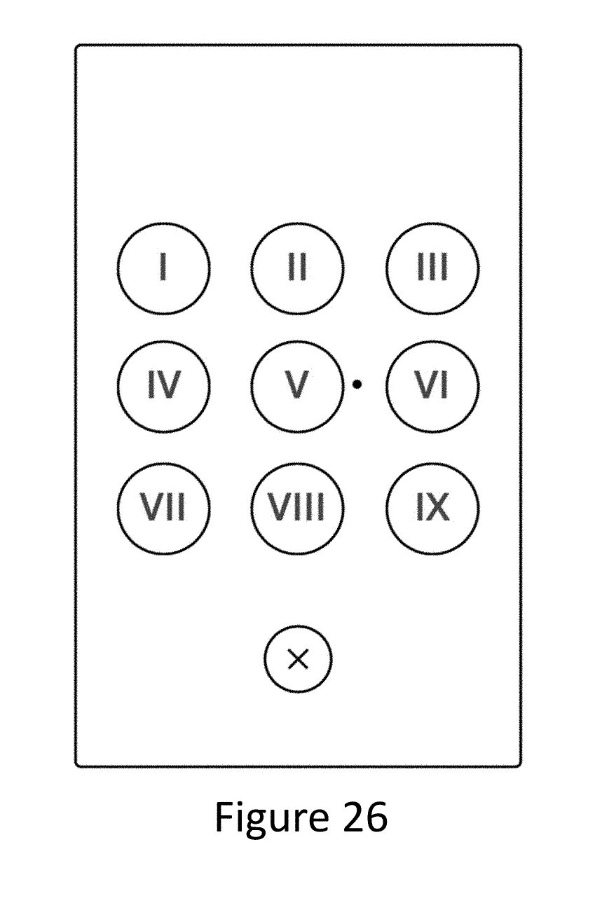

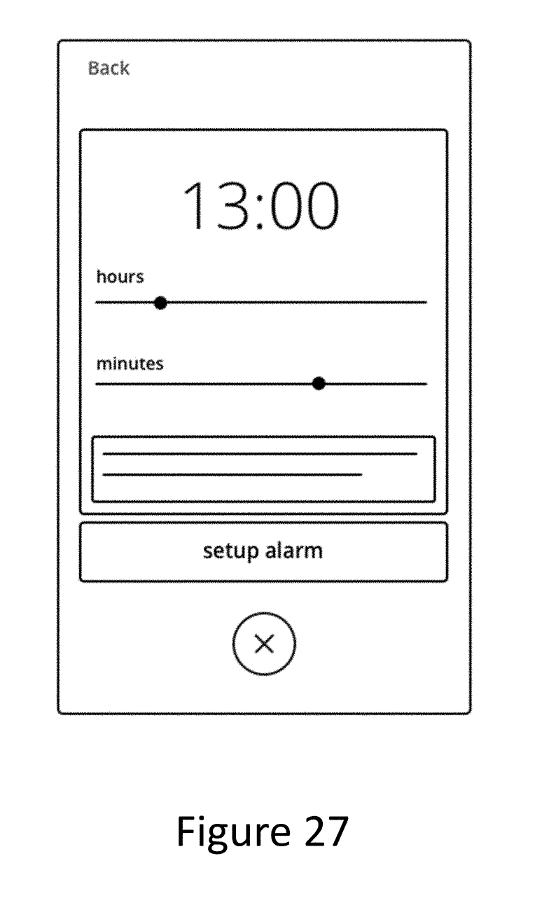

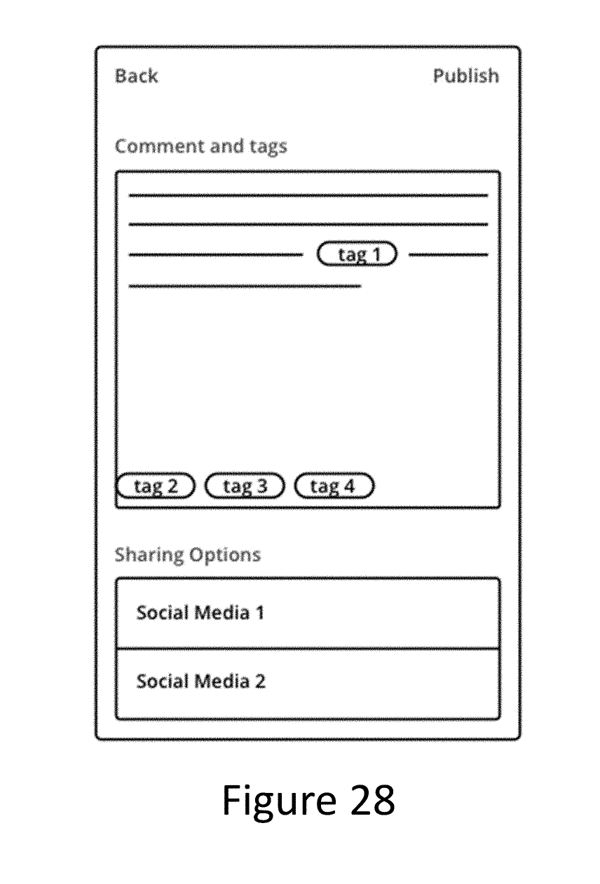

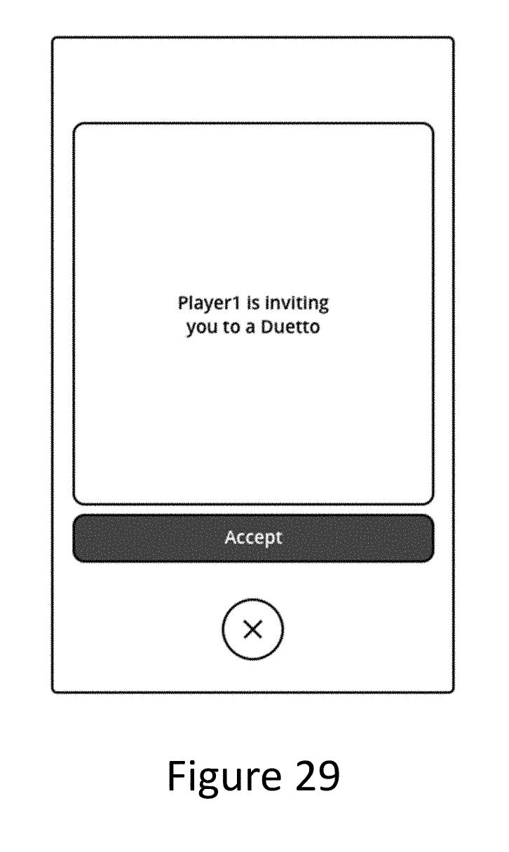

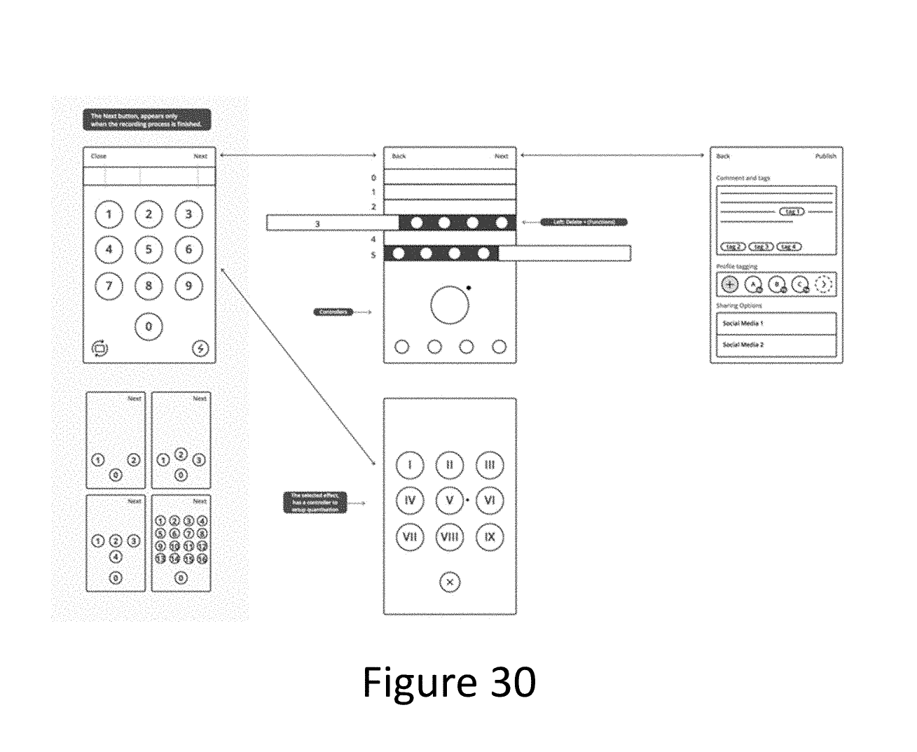

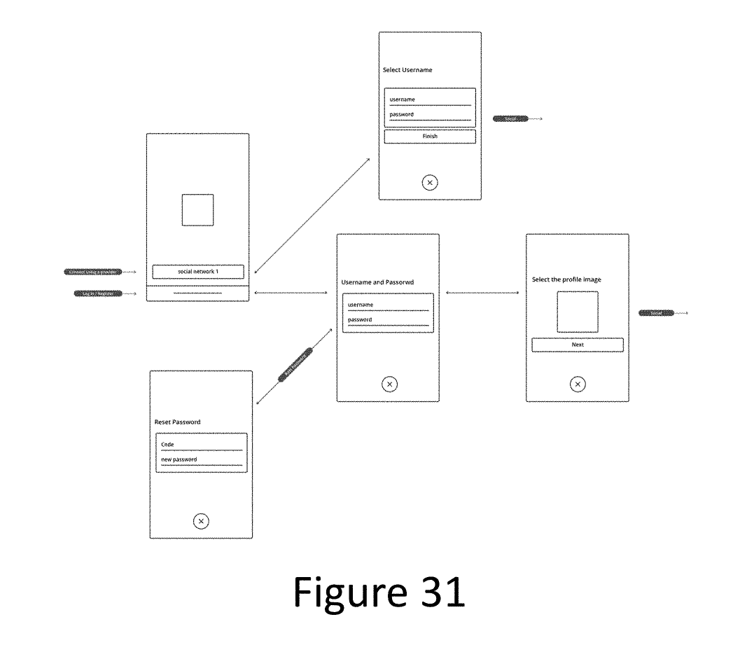

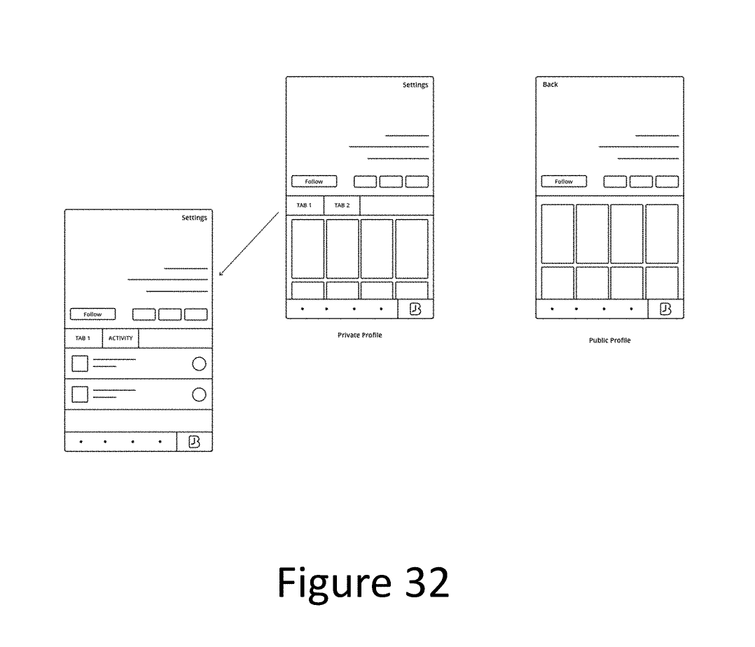

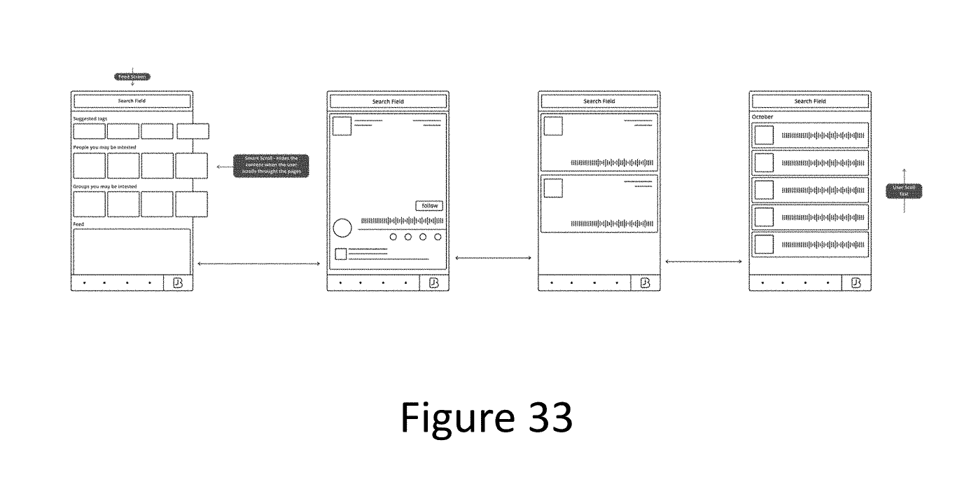

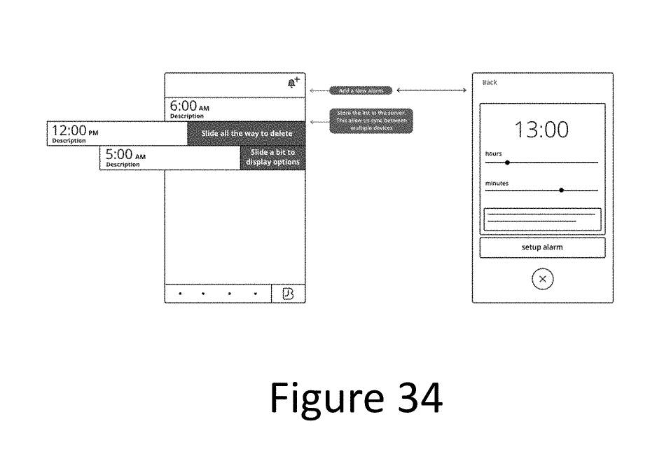

Even more additional embodiments may include an invite window. The invite window may be configured to appear for the player or multiple players invited to participate in the multiplayer mode. Now referring to FIG. 15, a user is shown invited to join a 2 player “duetto,” although other multiple player configurations, as previously discussed, would also be available.

The standard application may come with 2 trigger buttons, with additional buttons released to users through a number of following ways including: purchase of new trigger buttons from an online store or alternative ecommerce stores like Amazon or eBay; exchange their trigger buttons at the market place for other user's buttons, similar to how digital items are exchanged in online games like World of Warcraft; locate trigger buttons through the augmented reality environments such as Pokemon in Pokemon Go and add them to their account; acquire trigger buttons through occasional releases based on user's geography, gender, organization affiliation (such as college, non-profit, band, etc.) season (holiday specials like Christmas gifts) and their active involvement in the application (the more you use the application, the more special buttons you have a chance of acquiring).

In embodiments, buttons allow the user to trigger different samples, sound effects, visual filters, and visual effects that would create visual graphics or process the entire recording screen during the alarm recording process. The user can choose whether they want the effects and samples that are triggered quantized or triggered on a flexible grid. A number of quantization models would be available to users in the future to allow different levels of swing to be applied to samples and effects that the user can trigger within the recording process. Pressure sensitivity (as found in iOS's 3D-Touch process) may also be utilized, thereby allowing users to be expressive with their recorded performance.

In other embodiments, a user may record an alarm while pressing the trigger buttons, thereby creating a performance pattern production environment similar to how a composition is done within a digital audio/video workstation. Such composition that combines their recorded alarm video performance with the triggering of samples, audio and visual effects can allow a completely unique customized multimedia production product.

As mentioned above, in embodiments, a user can start with 2 buttons only with a standard sound pack, and can have the opportunity to collect additional trigger buttons throughout their usage of the app, completely customizing their application's alarm recording setup. Such an accumulation can result in a large number of trigger buttons being placed in their individual recording screens and completely personalized to their production. Some buttons may be temporary, some permanent and some may be exchanged, sold and purchased at the marketplace.

In embodiments, there may be thousands of different trigger buttons available to users that a user can accumulate during their participation in the application's social network. These triggers are used to create an interactive play experience similar to how an arcade game is played whether the user can press different buttons to trigger different special outcomes. Embodiments are thereby able to create a production experience mixed with an arcade experience and customized to each individual user. This can allow for a rich pallet of sound and visual textures enhancing each individually created alarm.

For example, the user can sing and play the rhythm while singing within the recording screen. As another example, the user can record a performance while triggering a sound effect of the crashes and risers having culmination points highlighted and building up tension in their performance. For still another example, the user can record a visual while triggering different visual effects, such as an Andy Warhol multi-color effect, a twisted mirror effect, bubbles popping, an overexposed bright sun rise or an effect that will make the screen fill up with coffee. These are just some of the examples; embodiments may include thousands of other visual effects to process and enhance video al arms.

In still other embodiments, parents and friends are able to record alarms and notifications with the intent of being shared within a closed community of designated users (friends) while not being available to a large number of people

In another, non-limiting, example new and upcoming bands, comedians, actors/actresses and impersonators are able to use the disclosed application as a way to increase exposure.

The application described herein introduces unique ways to grow and monetize user-created content. In embodiments, a record label interested in promoting a new album by the artist may be allowed to purchase a button to be released to multiple users with the sample pack from that artist's newly released album. Users can then have a new trigger button appear with the samples from the artist album at their alarm recording screen. The user can then record their alarm with the standard samples as well as the sample pack released by the label of the artist.

In other embodiments, a company, such as Starbucks, may be given the option to sponsor a button. A set of visual effects can be made temporarily available for the user, such as a screen filling with coffee or bagels floating around. During the autumn months, pumpkins and spice can slam into each other to make the wildly popular pumpkin spice latte. These video effects, in embodiments, can be triggered upon pressing a trigger button provided by such sponsors.

In still other embodiments, a news company like BBC may be offered the chance to use the application to showcase a short set of daily news. A custom set of audio and video triggers can be used by the news company to reflect their sound effects and video transitions to make it consistent with their brand. The ability to add direct news feeds can be sold to network news sources, allowing them to produce the news and then upload it directly to the application, bypassing the application's recording process and allowing the major media companies to use their production facilities to create their content and the upload it to their channel. This can be done for every major news channel, celebrity, or politician, allowing a monthly revenue to be generated for the service that supports the application from such a customized set of audio/video triggers and video upload feeds.

As the network grows, embodiments can provide popular users the chance to earn money with their skills. Embodiments provide them such opportunity by allowing them to make money with their video alarms. Such users can create private channels and charge other users for subscribing to those channels. Embodiments of the application can charge a small fee to these paid users for each monetized subscription.

Still even other embodiments allow users to trade the trigger buttons, sounds effects, modules, quantization modes, post production and performance effects as well as other features that might affect the look and performance of the app similar to how digital items are traded in online games such as World of Warcraft. In embodiments, users can trade those trigger buttons, effects, VSTs, samples and to have other users bid on those buttons, modules, modes and features and purchase them, granting an economy to these items. As the application grows, this will open up new monetizing and customization opportunities making using the application very interesting as a process of scarcity will be intrinsic to the value of many different items.

Even further embodiments provide for selling audio and video effect triggers. If a rare set of video alarms is purchased, it can become a signature set of some producer and used only by a small number of users. Monetizing on those rare sound samples, audio and video effects, music keyboards and other highly customizable gear will introduce a new dimension for what is possible to sell in the app.

Still even other embodiments provide the ability to incorporate ads within scrollable elements.

As the application grows it may be opened up for authorized 3rd party developers to build their own visual and sound collections and to sell them on the marketplace through a revenue shared model. The developers will set up a limited number of packs to be sold to create scarcity for most units, with some being permanent but the majority not being permanent. Embodiments may also include a limited time duration of the usages that set of effects, modules, features, models or samples that can be used before disappearing to make those multimedia performance and post production (editing) tools even more valuable and scarce, thus boosting their value.

As the community and processing power of the devices increases, embodiments include introducing a set of virtual instruments (aka VSTs) to be used by triggering everything from a voltage controlled oscillator effect, LFOs to frequency and timbre modulation, and audio and MIDI effects. Those VSTs will be controllable through MIDI by a MIDI controller allowing people not only to record rhythm patterns, sounds and visual effects but also to play music compositions and operate drum machines using their bluetooth or MIDI cable connected keyboards and controllers. By doing so, a platform for VST and MIDI controller manufacturers to use their instruments and MIDI controllers is opened up, not only for desktop digital audio workstations such as Logic, ProTools and Ableton Live, but also for this new mobile centered performance environment. This can allow for the creation of a full-fledged performance with knob tweaking, fader movement, planned automation programming with LFO and envelopes, and a number of modulation options previously only available in the digital audio workstations. The VST's would then be available for purchase from a marketplace for a revenue share model. Embodiments include one channel recording, although other embodiments include an advanced mode that opens up other audio and video tracks to be edited and automated in the post production environment.

In the marketplace of various embodiments, users are also be able to sell memorabilia like t-shirts, cups, hats, MIDI and Bluetooth controllers, and more, making the marketplace not only a destination for virtual objects but also for physical ones.

Specifically regarding the smart scroll technology, in embodiments if a user scrolls slowly, the scroll displays the regular size feed and/or objects, but if the user starts to scroll faster the elements such as video, comments, cards regular text, profiles or anything else in this scroll start to compress to narrower or smaller elements and in some embodiments even completely disappear entirely based on the speed of the scroll. This feature allows a much bigger amount of data to be scrolled through much faster, and allow the user to get to the lower information much faster. While the scroll is active and the user scrolls through it, this “smart scroll” can present the category names, dates or other sorting information either above the feed or top of the page or right on it—thus creating a system of navigation that might not require clicking on menu and submenu options

This smart scroll feature, in embodiments, can operate in the horizontal as well as vertical directions.

While scrolling information such as dates, alphabetic order and other overseeing categorization can be displayed upon such scroll.

This feature can make it much easier for a user to browse through a big amount of information and can be used on a number of application pages, such as profile screen, feed screens, home screen, future marketplace, activity tab, window and other screens and windows that might require scrolling, dealing with videos, snippets, pictures, videos, cards, buttons, or just text, compressing the scroll based on the speed of the scroller to a smaller view for the objective of a faster scroll. The amount the finger will scroll the surface in the given period of time will determine the compression of the scroll.

In embodiments, a pressure sensor may be added to the smart scroll to change the scroll even more, thus if the person presses harder the scroll might create more functionality in that action of scroll.

Although embodiments focus on the application as a pre-production multimedia environment, it may also be used in some embodiments in a live mode. This allows users and channels to broadcast their multimedia content to millions of followers live.

Embodiments of the application also include an API, thereby allowing 3rd party application developers, celebrities and media channels to broadcast different content and build communities around them.

Still other embodiments of the application feature a number of free and paid channels that provide a highly customized set of content to the users, such as news networks.

Still other embodiments include a marketplace to trade, bid, sell and purchase rare triggers.

Even still other embodiments include an advanced mode, allowing users to do post production on audio and video tracks.

Channels and customized sound triggers for networks and paid channels to users who would like to monetize their channels are also used in embodiments.

Further embodiments provide special placement of sponsor triggers with custom sound effects, visual filters, visual effects and samples.

Additional embodiments support virtual synthesizers, virtual effects processors, keyboards, record scratching, performance effect boxes, knob and button effects, drum machines as well physical MIDi and Bluetooth controllers to control those units, sound samples, effects as well as visually triggered effect and content.

Even additional embodiments include a number of video and audio filters to be applied to the multimedia content produced by people to make them further customizable.

Still even additional embodiments allow for different models of quantization and swing to be used and created by users.

Seasonal special sound and visual effects and filters are also provided in embodiments.

Furthermore, embodiments feature geo-targeting features that allow users in different locations to win special features, codes and points that could be used for the merchandise, trigger buttons, modules, modes, VST synths, VST effects, visual effects, animation and overall functionality of the app.

Embodiments also feature unconventional models of sharing of the items within the app, that can be spread among users similar to how viruses spread, such as “infesting” nearby users with some cool functionality, buttons, modules, modes, video/audio performance and edit effects, visual interfaces and cool application features.

Additional embodiments prevent the integration of 3rd party social networks with the system of the present disclosure. Embodiments may also prevent networks, such as YouTube from integrating with the system and its alarm as well.

Embodiments may further provide real time style transfer & merging of cross media style transfers. In this context, Real Time Style Transfer Claims refers to methods of transferring a style to a video in real time. What it means is that the style transfer can be used by performers or applied as a module to effect any piece of medium's style in real time.

In embodiments, the process is divided into 3 stages: Data Splitting, Correlation and Merging.

The stages may be described as:
a. Stage one, receive the data and pass it through a sequence of detectors and filters, that extract the scene information and break it in chunks of data;
b. Stage two process these chunks of information making a correlation with the desired style; and
c. Stage 3 reassemble the image and generate the output to the user.

In the case of the application of the present disclosure, it means that performers who are recording video alarms are able to get the video effect trigger buttons displayed in their alarm recording screen that will allow them to trigger video effects together with audio effects and audio samples as if they are playing a musical instrument or a drum machine, thereby creating a piece of multimedia performance.

Other Practical applications of these methods are: Augmented Reality systems can produce scene descriptors and transfer the style in real time to the user's view; Video Games instead develop the virtual world vertex by vertex as in the traditional approach, can create the content by using the descriptors of the scene and user's input, that are mapped using the style transfer to generate the target scene; Real Time video processing, applying the style transfer to image captured by the user's camera; Multimedia Performance that will allow multimedia Producers to perform pieces of composition and trigger the custom based multimedia filters on the fly like a DJ or Music Producer triggering different effects, loops and samples in realtime.

The application of the present disclosure is the first application that allows the real time usage of such style transfers. It is also the first application that allows the performance functionality with those style transfers like a DJ or Producer applying an array of styles to create a multimedia composition

### Merger of Cross Medium Transfers Claim

If a pattern can be extracted from any piece of medium the entire pattern or a portion of that pattern can be recreated in the different medium in any type of its intensity. What this means is a method of mixing different elements of mediums together to constitute an output to affect a new medium or affect already existing textual, auditory, visual, musical, environmental and even sensory mediums

An important part of this process is that the source of style isn't limited to a single medium like Video to Video, Books to Book Music to Music, Voice to Voice, Phrase to Phrase, Speed to Speed, Timbre to Timbre etc. . . . . Embodiments of the system can mix the styles and mediums in a way how humans either can't or would find it very hard to do and control the mix by specifying how much influence a particular data stream or portion thereof has in the filter. Embodiments may use multiple filters, which can work independently of each other or together constituting one overall 100% output where the % of intensity of a specific source will be applied to a new piece of any type of media and it's sub sections like timbre, speed, volume, vibe, atmosphere, phrasing, harmonies, melodies, colors scheme, video or movie medium distortion. Any piece of Literature, Any Text, Multimedia, Music, Soundscape, Augmented Reality, Virtual Reality, Existing Video, Any existing Movie, Real Time Video, Timbres, Phrasing, Distortion of the Medium, Voice, Timbre, Phrasing, Characters and other stylistic elements that can be extracted from the source via the style transfer can constitute the overall 100% of output of their effect on the new or existing and currently affected piece of medium.

In such embodiments, video and audio effects are created from style transfers from a number of mediums: Books, Regular Text, Music, Melodies, Harmonies, Breaths, Sounds, Intonation, Timbre, Speed, Phrasing, Dynamics, Phasing, Compression, Character's, Style/Behaviors of Characters, Settings, Environments. As long as the pattern can be determined in the sampled source the style of that pattern can be moved to the multimedia tools of the present disclosure.

Other Practical applications of these methods are: the extraction can take place from books, recreating the characters and/or overall style/emotions of a particular piece of literature; in music it would be possible to extract the harmonic, dynamic, phrase, melodic patterns, or in case of sung music also timbre and word patterns and apply them to the different piece of music while preserving the other chosen elements; a system that can detect the unique traces of any artist, song, poetry, writer, composer, performer, phrasing, atmosphere, sounds, medium or painter or painting, like Rembrandt painting and transfer specified elements to the target, or get the text in the Alice in Wonderland from Lewis Carroll and recreate the characters in augmented reality with those characters modes of behavior extracted out of the book; the final filter does not need to have an extraction from only 1 Style transfer and the system can merge transferred styles form a number of diverse sources.

An example of the aforementioned functionality is that such functionality makes it possible to mix 10% of Early Van Gogh Style, 20% Da Vinci of Davinci's Sketches and 20% Vivaldi's Melodies, 5% Richie Hawtin Techno sounds, 5% of cirque du soleil colors 10% of Mars landscape elements recorded on video, 15% of ambience from Edgar Allan Poe, and 7.5% of random character and their behaviours from Goethe's Faust and 7.5% of characters and their behaviours of Forrest Gump Movie to create a filter that will affect the overall new or already existing textual, auditory, visual, musical and even sensory mediums. Another example can be 50% real unfiltered medium, 25% would be edgar alan poe style, and 5% Cirque du soleil colors and 20% martian landscape. As you can see, this mixing functionality can open up a very diverse set of application—mostly for the multimedia processing as it allows the creation of characters, with styles and settings either 100% processed by those styles or partially augmented from styles sampled from a variety of different mediums and then mixed together at the end.

In embodiments, values can transfer across mediums, referred to as a Cross Medium Style Transfer, allowing people to extract characters of a books or the overall feel of those books, phrases and soundscapes of music to appear as stylistic elements or augmenting a piece of video, Virtual Reality or Augmented Reality.

In embodiments, the values of style transfer does not need to absolute and it is possible to customize what percentage of say book 1 characters, book 2 ambience is desired together with the elements from phrasing from piece of music. These “styles” to be transferred are from any kind of media content, as images, music, sounds, videos, text.

The foregoing description of the embodiments of the invention has been presented for the purposes of illustration and description.

Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

What is claimed is:

1. A social media alarm system, said social media alarm system comprising:
computer readable instructions downloadable onto a smart phone having built-in audio and video recording capabilities for configuring the smart phone to provide a user with the capability to:
record alarms using said built-in audio and video recording capabilities;
make said alarms available to users of similarly-configured smart to phones; and
play an alarm or alarms at a specific time or times.

2. The social media alarm system of claim 1 wherein said alarms are video alarms.

3. The social media alarm system of claim 2 further comprising trigger buttons that are made available to a user during recording of an alarm, wherein said trigger buttons are configured to trigger pre-configured actions.

4. The social media alarm system of claim 3 wherein said pre-configured actions are manipulations of the recording.

5. The social media alarm system of claim 3 wherein said pre-configured actions are sound effects.

6. The social media alarm system of claim 3 wherein said pre-configured actions are animations.

7. The social media alarm system of claim 3 wherein at least some of said trigger buttons are of a limited quantity.

8. The social media alarm system of claim 7 wherein said trigger buttons may be traded between said users.

9. The social media alarm system of claim 7 wherein said trigger buttons may be sold from one user to another.

10. The social media alarm system of claim 1 wherein a user may choose to have a new alarm algorithmically generated.

11. The social media alarm system of claim 10 wherein said algorithmically generated alarm is based on said user's alarms.

12. The social media alarm system of claim 10 wherein said algorithmically generated alarm is based on the alarms of other users.

13. The social media alarm system of claim 10 wherein said algorithmically generated alarm is based on a group or groups of alarms categorized by various attributes thereof.

14. The social media alarm system of claim 1 wherein a user may follow groups or specific users and thereby receive notifications of alarms produced by them and subsequently incorporate said alarms into their smart phone.

15. The social media alarm system of claim 1 wherein an alarm may be incorporated into a group of alarms through the use of a hashtag followed by an alphanumeric string representative of the group.

16. The social media alarm system of claim 1 wherein said computer readable instructions also provide a user with the capability to browse the alarms of others.

17. The social media alarm system of claim 16 wherein said browsing of the alarms of others is provided for in a feed-style layout.

18. The social media alarm system of claim 16 wherein elements in said feed are vertically compressed proportionally to the speed at which a user scrolls through them.

19. The social media alarm system of claim 1 further comprising a search bar configured to allow a user to search the alarms of other users.

20. The social media alarm system of claim 19 wherein said search bar contains a random message that is in the form of a question prompting the user for a response.
